(19) United States
(12) Patent Application Publication
(10) Pub. No.: US 2024/0185028 A1
(43) Pub. Date: Jun. 6, 2024

(54) HIERARCHICAL DEEP LEARNING NEURAL NETWORKS-ARTIFICIAL INTELLIGENCE: AN AI PLATFORM FOR SCIENTIFIC AND MATERIALS SYSTEMS INNOVATION

(71) Applicant: NORTHWESTERN UNIVERSITY, Evanston, IL (US)

(72) Inventors: Wing Kam Liu, Oak Brook, IL (US); Sourav Saha, Evanston, IL (US); Satyajit Mojumder, Evanston, IL (US); Derick Andres Suarez, Evanston, IL (US); Ye Lu, Evanston, IL (US); Hengyang Li, Evanston, IL (US); Xiaoyu Xie, Evanston, IL (US); Zhengtao Gan, Evanston, IL (US)

(21) Appl. No.: 18/286,619

(22) PCT Filed: Apr. 20, 2022
(86) PCT No.: PCT/US2022/025496

§ 371 Date: Oct. 12, 2023

Related U.S. Application Data
(60) Provisional application No. 63/177,517, filed on Apr. 21, 2021.

(51) Int. Cl. G06N 3/045; G06N 3/096; G06V 10/40; G06V 10/70

(52) U.S. Cl. CPC G06N 3/045; G06N 3/096; G06V 10/40; G06V 10/70

(57) ABSTRACT

A Hierarchical Deep Learning Neural Networks-Artificial Intelligence system for data processing, comprising a data collection module collecting data; an analyzing component extracting at least one feature from the data, and processing the extracted at least one feature to produce at least one reduced feature; and a learning component producing at least one mechanistic equation based on the at least one reduced feature.

### CROSS-REFERENCE TO RELATED PATENT APPLICATION

This application claims priority to and the benefit of U.S. Provisional Patent Application Ser. No. 63/177,517, filed Apr. 21, 2021, which is incorporated herein in its entirety by reference.

### STATEMENT AS TO RIGHTS UNDER FEDERALLY-SPONSORED RESEARCH

This invention was made with government support under 1934367 and 1762035 awarded by the National Science Foundation. The government has certain rights in the invention.

### FIELD OF INVENTION

The present disclosure relates to the technical field of Hierarchical Deep Learning Neural Networks-Artificial Intelligence (HiDeNN-AI) which uses machine learning methods to process input data, extract mechanistic features from it, reduce dimensions, learn hidden relationships through regression and classification, and provide a knowledge database, and hardware and/or software thereof.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section.

Mathematical scientific principles allow predictions which drive new discoveries and enable future technologies. Unfortunately, development of new scientific principles is often trailing the pace of new inventions with the sheer volume of data that are being generated across multiple spatial and temporal scales.

Therefore, a more efficient method for development of new scientific principles, knowledge creation processes and material systems and simulation technology innovation, aimed at tackling the aforementioned types of problems, is imperatively needed.

### SUMMARY OF INVENTION

In light of the foregoing, this invention discloses a HiDeNN-AI platform uses machine learning methods such as active deep learning and hierarchical neural network(s) to process input data, extract mechanistic features from it, reduce dimensions, learn hidden relationships through regression and classification, and provide a knowledge database. The resulting reduced order form can be utilized for design and optimization of new scientific and engineering systems.

In one aspect of the invention, a Hierarchical Deep Learning Neural Networks-Artificial Intelligence (HiDeNN-AI) system for data processing comprising a data collection module collecting data; an analyzing component extracting at least one feature from the data, and processing the extracted at least one feature to produce at least one reduced feature; and a learning component producing at least one mechanistic equation based on the at least one reduced feature.

In one embodiment, the data is collected from at least one of the sources comprising measurement and sensor detection, computer simulation, existing databases and literatures; the data is in one of formats comprising images, sounds, numeric numbers, mechanistic equations, and electronic signals; the data collected by the data collection module is multifidelity.

In one embodiment, the analyzing component further comprising a feature extraction module extracting the at least one feature from the data; and a dimension reduction module reducing the size of the at least one feature.

In one embodiment, the at least one extracted feature has mechanistic and interpretable nature.

In one embodiment, the dimension reduction module produces at least one reduced feature by reducing the size of the at least one extracted feature; wherein the dimension of the at least one extracted feature is reduced during the reducing process.

In one embodiment, at least one non-dimensional number is derived during the process of reducing the size of the at least one extracted feature.

In one embodiment, the at least one extracted feature comprises a first extracted feature and a second extracted feature.

In one embodiment, the first extracted feature is reduced to produce a first reduced feature, and the second extracted feature is reduced to produce a second reduced feature

In one embodiment, the learning component further comprising a regression module analyzing the at least one reduced feature; and a discovery module producing at least one hidden mechanistic equation based on the analyzing results of the at least one reduced feature.

In one embodiment, a relationship between the first reduced feature and the second reduced feature is established by the regression module during the analyzing process.

In one embodiment, the analyzing process comprising a step of regression and classification of deep neural networks (DNNs).

In one embodiment, a model order reduction is produced by the discovery module based on the hidden mechanistic equation.

In one embodiment, the system further comprising a knowledge database module, wherein the knowledge database module stores knowledge comprising at least one component comprising: the collected data, the at least one extracted feature, the at least one reduced feature, the relationship between the reduced features, the hidden equation, and the model order reduction.

In one embodiment, the system further comprising a developer interface module in communication with the knowledge database module, wherein the developer interface module develops new knowledge for storing in the knowledge database module.

In one embodiment, the develop interface module is in communication with at least one of the collection module; the analyzing component, and the learning component.

In one embodiment, the develop interface module receives a data science algorithm input from a user.

In one embodiment, the analyzing component and the learning component process the collected date using the data science algorithm.

In one embodiment, the system further comprising a system design module in communication with knowledge database module.

In one embodiment, the system design module produces a new system or a new design using the knowledge in the knowledge database module, and without using the data collection module, analyzing component, and learning component.

In one embodiment, the system further comprising a user interface module for receiving inputs from the user and output knowledge, the new system, or new design to the user.

In one embodiment, the system further comprising an optimized system module optimizing the new system or new design according to the received inputs.

In another aspect of the invention, a method for data processing using a Hierarchical Deep Learning Neural Networks-Artificial Intelligence (HiDeNN-AI) system, comprising collecting data with a data collection module; extracting at least one feature from the data and processing the extracted feature to produce at least one reduced feature with an analyzing component; and producing at least one mechanistic equation or model order reduction based on the at least one reduced feature with a learning component.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 illustrates a schematic diagram of HiDeNN-AI with different modules.

FIG. 2 illustrates HiDeNN-AI framework for an efficient N-parameter mechanistic model.

FIG. 3 illustrates using Hierarchical Deep learning Neural Networks (HiDeNN) to learn from a system (Piano sound) and transfer the knowledge for a new system (Guitar sound).

FIG. 4 illustrates short-time Fourier transform if a signal (sound).

FIG. 5 illustrates extracted features of A4 piano sound and guitar.

FIG. 6 illustrates a process of data collection and generation for sound data.

FIG. 7 illustrates a process of dimension reduction for sound data regarding frequencies, amplitudes and damping coefficients.

FIG. 8 illustrates a process of mechanistic learning through regression and a process of optimization of the feed forward neural network training.

FIG. 9 illustrates system and design of sound reconstruction.

FIG. 10 illustrates a process of audio normalization.

FIG. 11 illustrates results of the HiDeNN model for the functional composite

FIG. 12 illustrates a diagram of HiDeNN-AI Instrument Sound Reconstruction.

FIG. 13 illustrates a process of mechanistic machine learning for decision making.

FIG. 14 illustrates a multimodal data fusion for modeling and simulation.

FIG. 15 illustrates a comparison between experimental data and DimensionNet prediction.

FIG. 16 illustrates a process of dimension reduction during which the number of elements are clustered.

FIG. 17 illustrates a process of regression and classification for materials system knowledge.

FIG. 18 illustrates a process of regression and classification using Hierarchal Deep learning Neural Network using module (400).

FIG. 19 illustrates a process of system and design of a non-orthogonal woven composite in multiscale.

FIG. 20 illustrates another process of system and design of a non-orthogonal woven composite in multiscale.

FIG. 21 illustrates a comparative picture of state-of-the-art AI tools in computational science and engineering and the proposed Hierarchical Deep Neural Network (HiDeNN) framework. HiDeNN offers the advantage of being a unified framework to solve the problem in computational science and engineering without resorting to different set of tools for different types of problem.

FIG. 22 illustrates shows detail construction of the proposed HiDeNN framework.

FIG. 23 illustrates the inputs of the HiDeNN element are the nodal coordinates, (x, y), while the output are the nodal displacements, uₓand u_{y}.

FIG. 24 illustrates the assembled neural network by the unit neural network in FIG. 23 for solving the 2D elastic problem.

FIG. 25 illustrates schematic diagram of the test problem, a square domain with four initial elliptical voids. The dimensions of the square domain are 2×2. Young's modulus of the material is 105 and Poisson's ratio is 0.3. The left side of the domain is fixed while a uniform load of F=20 is applied to the right-side of the domain.

FIG. 26 illustrates computational iterations and time of HiDeNN with respect to the number of degrees of freedom. Computational time increases slightly faster than the degrees of freedom. (a) Iteration number versus degrees of freedom, (b) Computational time versus degrees of freedom

FIG. 27 illustrates converged conformal mesh and the corresponding FEM results (von Mises stress) for the test problem with four elliptical holes. (a) Full domain with four elliptical holes, (b) detail of the converged mesh near the stress concentration, (c) stress distribution inside the full domain for the converged solution in Abaqus.

FIG. 28 illustrates comparison of the discretization between Abaqus and the HiDeNN for stress concentration regions after learning the nodal positions.

FIG. 29 illustrates schematic of the fluid flow in a rough pipe with dimensional quantities, including inlet pressure p1, outlet pressure p2, pipe diameter d, pipe length 1, average steady-state velocity U, kinematic viscosity v, and surface roughness Ra.

FIG. 30 illustrates schematic of the dimensionally invariant deep network (DimensionNet). The four inputs are p1=U, p2=v, p3=d, and p4=Ra. The output is u=log(100λ).

FIG. 31 illustrates distribution of the identified weights of the basis, i.e., ω⁽²¹⁾ and ω⁽²²⁾ from snapshot results with high R2 (greater than or equal to 0.98) and different training BIC thresholds: (a) no BIC threshold; (b) results with BIC 0; (c) results with BIC −750; and (d) results with BIC −1500.

FIG. 32 illustrates comparison between experimental data and DimensionNet prediction: (a) R2 for the training dataset; (b) R2 for the test dataset; and (c) captured relationship between identified dimensionless numbers and resistance factor.

FIG. 33 illustrates schematic diagram outlining the AI framework to link thermal history with part performance.

FIG. 34 illustrates Binning technique used. (a)The thermal history is divided into bins of 50° C. (b) Time spent in each bin is taken as input and output vector consists of ultimate tensile strength.

FIG. 35 illustrates variation in the R2-score with considered number of features in Random Forest algorithm. Shaded regions represent 95% confidence interval.

FIG. 36 illustrates proposed HiDeNN framework to solve Type 1 problem.

FIG. 37 illustrates outline of the solution scheme used for this example of a type 2 problem, including example images and the process of CPSCA-based fatigue analysis.

FIG. 38 illustrates proposed HiDeNN framework for type 2 problem.

FIG. 39 illustrates the structure of data processing on experimental measurement and process-structure predictions.

FIG. 40 illustrates detail construction of the proposed HiDeNN transfer learning framework. The input layer takes in space, time, and parameters.

FIG. 41 illustrates (a) The illustration of the 3-scale multiscale model setup for 3-D braided composite laminate three point bending test.

FIG. 42 illustrates proposed HiDeNN structure for Type 3 problem.

FIG. 43 illustrates one embodiment of ICME-MDS method for AM fatigue prediction.

FIG. 44 illustrates another embodiment of ICME-MDS method for AM fatigue prediction.

FIG. 45 illustrates another embodiment of ICME-MDS method for AM fatigue prediction.

FIG. 46 illustrates different stages and physics of fatigue life (a) S-N Curve (Applied stress fatigue life relation); (b) Example S-N curve.

FIG. 47 illustrates low cycle fatigue modeling.

FIG. 48 illustrates computational model of low cycle fatigue.

FIG. 49 illustrates high cycle fatigue modeling with microstructure.

FIG. 50 illustrates high cycle fatigue modeling with microstructure.

FIG. 51 illustrates space-time self-consistent clustering analysis (XTSCA).

FIG. 52 illustrates process-structure ML using published data.

FIG. 53 illustrates pre-training weights and biases of the neural network.

FIG. 54 illustrates EBM process and DMLS process with HIP post-processing.

FIG. 55 illustrates ML model for fatigue prediction, EBM without HIP.

FIG. 56 illustrates mechanistic knowledge transfer model, EBM+DMLS, no HIP.

FIG. 57 illustrates that knowledge transfer reduces learning iterations and errors.

FIG. 58 illustrates ML model for fatigue prediction, EBM with HIP

FIG. 59 illustrates mechanistic knowledge transfer model, EBM+DMLS with HIP.

FIG. 60 illustrates that knowledge transfer reduces learning iteration and errors.

FIG. 61 illustrates a process and results that ICME-mechanistic knowledge transfer for better extrapolation.

FIG. 62 illustrates prediction of spinal deformity curve progression using the HiDeNN.

### DETAILED DESCRIPTION OF THE INVENTION

The present invention will now be described more fully hereinafter with reference to the accompanying drawings, in which exemplary embodiments of the present invention are shown. The present invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. The use of examples anywhere in this specification, including examples of any terms discussed herein, is illustrative only and in no way limits the scope and meaning of the invention or of any exemplified term. Likewise, the invention is not limited to various embodiments given in this specification.

The current invention introduces the Hierarchical Deep Learning Neural Networks-Artificial Intelligence (HiDeNN-AI), which is a mechanistic artificial intelligence framework for the development of new scientific principles, knowledge creation processes and material systems and simulation technology innovation, aimed at tackling the aforementioned types of problems.

In essence, HiDENN-AI platform mimics the way human civilization has discovered solution to difficult and unsolvable problems from time immemorial. Instead of heuristics, the HiDeNN-AI uses machine learning methods such as active deep learning and hierarchical neural network(s) to process input data, extract mechanistic features from it, reduce dimensions, learn hidden relationships through regression and classification, and provide a knowledge database. The resulting reduced order form can be utilized for design and optimization of new scientific and engineering systems.

HiDeNN-AI is an integrated MDS software platform capable of immediately extending the currently available commercial and standalone software functionality with better, quicker, and more accurate scientific and engineering simulations. As will be demonstrated below, the unique features of the HiDeNN-AI simulator are: (1) Systematic MDS approach to analyze system data and derive the scientific knowledge from it. (2) Mechanistic understanding of the critical process-structure-property-performance (PSPP) linkage that can be employed to predict systems performance and optimize the manufacturing processes. (3) Highly integrated mechanistic data-driven approach to the development of composite material systems database providing a seamless interface with the current major commercial composites design/analysis software.

HiDeNN-AI and related data science techniques have shown a wide array of applications including data-driven modeling of elastic and elastic-plastic material laws and heterogenous material laws through component expansions, prediction of adolescent idiopathic scoliosis, data-driven characterization of thermal models, data-driven microstructure and microhardness design in additive manufacturing using self-organizing map, among others.

### Modules/Components and Functions of the HiDeNN-AI System

In certain aspects of the invention, as shown in FIG. 1, the construction of HiDeNN-AI has the following module (100)-(1000) components/modules and/or software systems.

This invention proposes a mechanistic artificial intelligence, framework, method, algorithms, software for design, optimization, and discovery of science for design of scientific/engineering processes or materials systems, comprising of ten integrated modules (100)-(1000).

Module (100) is multimodal data generation and collection module.

Module (100) collects data comes from multifidelity experimental, sensor, image, simulation, database, or literature. The term multifidelity means that the accuracy of data can be of multiple levels (high and low fidelity) depending on the source of the data. Experimental data may come in the form of measurement and sensor data that can be collected by transducing the signals into other formats. Imaging data may primarily consist of digital imaging data in the form of RGB (Red-Green-Blue) pixel. Computer simulation data may provide extra data to augment the database, along with any previous literature data.

Module (200) is mechanistic feature extraction module.

From the data collected in the module (100), mechanistic features are extracted through Fourier, wavelet, convolutional, Laplace or other methods. Traditionally, the features of data are decided by the users and it is not generally emphasized whether these features have any mechanistic significance or not. In contrast, in the HiDeNN platform of the present invention, the features have mechanistic and interpretable nature. For example, if wavelet transformation is applied to time series data, the data will be converted to the frequency domain and these frequencies will represent the process signature such as scan speed.

Module (300) is knowledge-driven dimension reduction and scaling module.

The mechanistically extracted features can still be very high-dimensional and difficult to process. In module (300), the size of relevant features can be reduced, and non-dimensional numbers can be derived to further understanding of the system. The purpose of this layer is twofold: extracting new physics-based features and reducing the dimension of the features. An example of such knowledge-driven dimension reduction can be shown for fluid mechanics problem where non-dimensional numbers such as Reynolds number can be discovered from data only.

Module (400) is mechanistic learning through regression and classification.

After identifying the reduced mechanistic features, their relationship can be analyzed through regression and classification of deep neural networks. Transfer and active learning is used to transfer the experimental knowledge in physics-based model which explains the experimental observations.

Module (500) is discovery of hidden mechanistic equation and model order reduction and calibration module.

This module primarily capable for discovery of hidden mechanistic equation and model order reduction wherein an explicit mechanistic equation relating input parameters to target properties can be formulated. This reduced order model can be based on mechanistic equation (Lipmann-Schwinger equation in Self-consistent clustering analysis and multiresolution clustering analysis method). Module (600) is knowledge database module.

All the previous modules (100)-(500) interact with the developer interface module (700), so as to store the knowledge in the knowledge data base module (600). In that sense, its primary objective is to work as a database for the analyzed system which can be further leveraged for a new system of interest.

Module (700) is developer interface module.

Developer interface module primarily interacts with the previous modules (100)-(600) and helps to develop the knowledge database. Developer interface module is the place for expert interaction with the data science algorithms and develop understanding of the system using scientific principles.

Module (800) is new system and design module.

In the new system and design module, a user can utilize the knowledge database to explore a new system and carry out new design. As all the modules are stored in the knowledge database, the computation or decision-making process is accelerated, and the design iteration loop are performed on the fly.

Module (900) is user interface module.

Through user interface module, a new user can try new parameters and new design without going through all the details of the module (100)-(600). All the queries made by the user for analysis of a new system can be readily availed from the knowledge database and a rapid decision can be reached.

Module (1000) is optimized system module.

In this module, the user can find the optimized system of his interest and analyze his results. The primary purpose of this module is to be the output of new system design.

### ILLUSTRATIVE EXAMPLES OF THE HIDENN-AI SYSTEM

In an embodiment of the invention, the HiDeNN-AI framework can be used to reconstruct and convert signal from one form to another. HiDeNN-AI can use less features, chosen based on mechanistic knowledge, compared to traditional methods such as convolutional neural network (CNN) and wavelet analysis. HiDeNN-AI has the ability to be applied for defect detection such as porosity, slags, and inclusion. System identification can be made much faster with HiDeNN-AI. Signal analysis and transmission is casier with HiDeNN-AI. Forensic analysis can be more accurate and predictive with HiDeNN-AI.

### Example 1—HiDeNN-AI for Computational Science and Egineering

### 1. Introduction

The present invention proposes that there are three major classes, or types, of problems puzzling the community of computational science and engineering. These three types are:
1.1. Type 1 or purely data-driven problems: The class of analyses with unknown or still developing governing physics but abundant data. For these problems, the lack of knowledge of physics can be compensated by the presence of considerable data from carefully designed experiments regarding the system response.
1.2. Type 2 or mechanistically insufficient problems with limited data: The term mechanistic refers to the theories which explain a phenomenon in purely physical or deterministic terms. Type 2 problems are characterized by physical equations that require complementary data to provide a complete solution.
1.3. Type 3 or computationally expensive problems: The problems for which the governing equations are known but too computationally burdensome to solve.

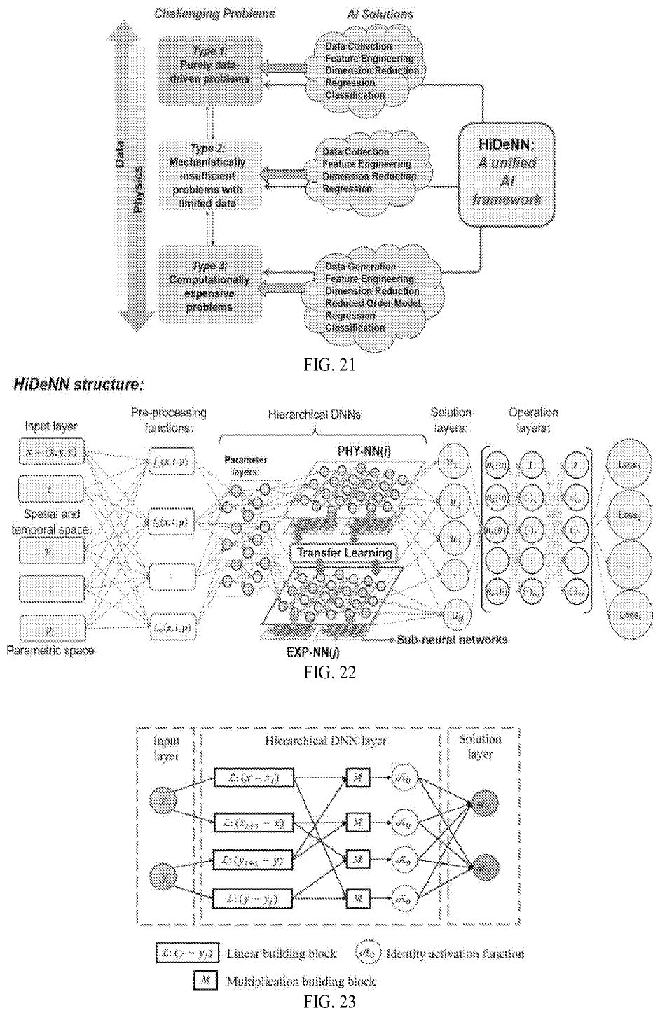

The present invention shows that artificial intelligence (AI), particularly a subset of AI, decp learning, is a promising way to solve these challenging problems. FIG. 21 shows AI tools currently in use to solve state-of-art computational science problems. FIG. 21 shows a comparative picture of state-of-the-art AI tools in computational science and engineering and the proposed Hierarchical Deep Neural Network (HiDeNN) framework. HiDENN offers the advantage of being a unified framework to solve the problem in computational science and engineering without resorting to different set of tools for different types of problem. The AI tools include data generation and collection techniques, feature extraction techniques (wavelet and Fourier transform, principal component analysis), dimension reduction techniques (clustering, self-organizing map), regression (neural network, random forest), reduced order models (can be something similar to regression techniques or more advanced technique like self-consistent clustering analysis (SCA) or Proper Orthogonal Decomposition (POD)) and classification (convolutional neural networks or CNN).

### 2. Hierarchical Deep Learning Neural Network (HiDeNN)

An example structure of HiDeNN for a general computational science and engineering problem is shown in FIG. 22. In particular, FIG. 22 shows detail construction of the proposed HiDeNN framework. The input layer takes in space, time, and parameter variables of a system. The input layer is connected to the pre-processing function, Hierarchical DNNs, and finally the solution layer. Governing equations can be obtained from solution layers through the operation layer and the loss function. Construction of HiDeNN framework is discussed in following points:
The input layer of HiDeNN consists of inputs from spatial (Ω), temporal (t), and parameter (D) spaces. The neurons of this layer serve as independent variables of any physical system.
The input layer of HiDeNN is connected to a set of neurons that represents a set of pre-processing functions f (x, t, p) where x, t, and p are position, time, and parameter vector, respectively. These functions can be thought of as tools for feature engineering. For example, the pre-processing functions can convert dimensional parameters into dimensionless inputs. Such conversion can be necessary for fluid mechanics problems where, for example, the Reynolds (Re) number is important.
The layer of the pre-processing functions is connected to structured hierarchical deep learning neural networks (DNN). Hierarchical DNN layers consist of parameter layers, customized physics-based neural networks (PHY-NN) or experimental-data based neural network (EXP-NN). In FIG. 22, the indices i and j indicate similar neural networks layers can be appended for both PHY-NN and EXP-NN, respectively. The PHY-NN refers to a neural network formulated from physics-based data and EXP-NN neural network is designed from experimental data.
In the hierarchical DNNs portion of the HiDENN of FIG. 22, we see multiple sub-neural networks connected (the red blocks). We define the sub-neural networks as stand-alone neural networks that can provide input to the PHY-NN or EXP-NN. This multi-level structure is the source of the name “Hierarchical” in HiDeNN.
The Hierarchical DNNs can be any type of neural network, including convolutional neural network (CNN), recurrent neural network (RNN), and graph neural network (GNN). In order to enhance the capability of PHY-NN or EXP-NN transfer learning technique can be adopted in the proposed structure.
Lack of data is of big concern in AI community. Available experimental data often come from dissimilar experimental or computational conditions making them hard to use directly in an AI framework. As one means of dealing with the problem, HiDeNN has provision for transfer learning in the Hierarchical DNN layer. The PHY-NNs and EXP-NNs can be trained separately with the available computational and experimental data. Later, these individual neural networks can be combined through transfer learning.
The Hierarchical DNN layer is connected to the solution layer. The solution layer represents the set of dependent variables of any particular problem.
To discover unknown governing equations from data, HiDeNN has operation layers. In this layer, the neurons are connected through weights and biases in a way that mimics the behavior of different spatiotemporal operators. Through proper training (i.e. minimization of the loss function in the HiDeNN), the operation layer can be trained to discover hidden physics from data.
The loss function layer of HiDENN contains multiple loss function terms as shown in the FIG. 22. Each loss function can either come from the hierarchical DNNs or the operational layers. These functions can be optimized simultaneously or separately depending on the problem. This unique feature of the HiDeNN provides the flexibility to solve problems with scarce and abundant data by combining it with physics.

### 3. Application of HiDeNN Framework

In this section, three examples of HiDeNN are discussed in detail to demonstrate the framework's capability.

### 3.1. HiDe VN for Learning the Discretization

In this example, the HiDENN is used to solve a solid mechanics problem and capture stress concentration by training the position of the nodes used for the discretization to minimize the potential energy of the system. In HiDeNN, the interpolation function for approximating the solution is obtained by constructing neural network and training the weights and biases simultaneously. FIG. 23 presents a 2D bi-linear HiDeNN element, N(x, y; w, b, A) at node (xI, yJ), constructed by using the well-defined building blocks. In particular, FIG. 23 shows a construction of the bi-linear HiDENN element at nodal (x_{I}, y_{J}) using building blocks. The input of the unit neural network is nodal coordinates (x, y), while the output is the nodal displacements (ux, Uy). Note that the weights and biases in the above neural network are functions of nodal positions (x_{I}*, y*_{J}). The training of the neural network is equivalent to find the optimally nodal positions to achieve optimal performance for the loss function in Eq. (1-1)

The arguments ω, b, and A are the weights, biases, and activation function of the neural networks. Here, both w and b are functions of nodal positions. Therefore, updating the weights and biases during training implies updated nodal coordinates. The interpolation function at (x_{I}, y_{J}) can be expressed as N(x, y; x_{I}*, y_{J}*, A) where x_{I}*, y_{J}* are the updated nodal positions. As illustrated in FIG. 23, the inputs of the HiDeNN element are the nodal coordinates, (x, y), while the output are the nodal displacements, ux and uy. When the nodal positions are fixed, HiDeNN is equivalent to standard FEM, while when the nodal coordinates, x_{I}*, y_{J}*, in the weights and biases are updated during training, HiDeNN is able to accomplish better results like the r-adaptivity in FEM. However, differentiating from stress-based error estimator in r-adaptivity, the proposed HiDeNN method updates the nodal position by learning the performance through structured deep neural networks. The updated nodal coordinates will replace the original nodal coordinates after the training process until the optimal solution accuracy is achieved.

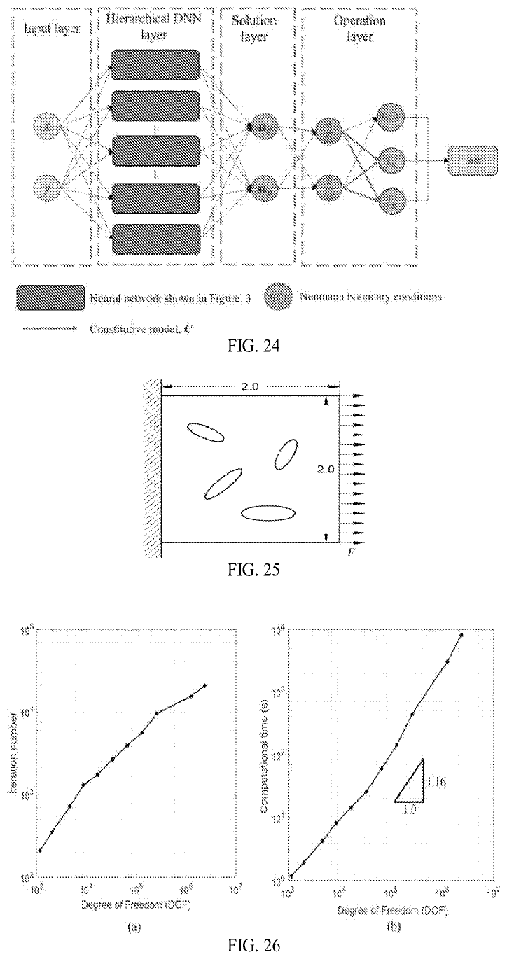

By assembling the HiDENN elements, a unified neural network is formed to solve any problem of interests. FIG. 24 shows the assembled neural network by the unit neural network in FIG. 23 for solving the 2D elastic problem. The input of the neural network is the nodal coordinates. The output is the solution of the nodal displacements. The operation layer is used to formulate the governing equations. The loss function is defined in Eq. (1-1).

In the operations layer, the neuron f₁(·) is used to formulate the Neumann boundary conditions while the Dirichlet boundary condition is automatically satisfied through the optimization of the loss function. The weights of green arrows in FIG. 24 represent the constitutive model, in this case, the stiffness matrix for an elastic problem. The neural network in FIG. 24 is a variation of the HiDeNN framework in FIG. 22 for solving the problems with known governing equations. The input is the spatial coordinates, the PHY-NN is the construction of the interpolation function and the solution is the displacements. The operation layer is used to define the loss function (total potential energy) given in Eq. (1-1) Here, the HiDeNN method is implemented in PyTorch v1.6.0, and the training for the variables, such as nodal displacements and nodal positions, is performed by using the autograd package in PyTorch on a laptop with an Intel(R) Core(TM) i7-9750H @2.60 GHz and an NVIDIA GeForce RTX 2060 Graphics Processing Unit (GPU).

$$ℒ ( {u}^{H} : f , t ) = \frac{1}{2} {\int }_{0} σ ( {𝓊}^{h} ) : s ( {u}^{b} ) d Ω - ( {\int }_{0} {u}^{k} \cdot fd Ω + {\int }_{{r}_{1}} {u}^{b} \cdot \overline{i} d Γ ) \qquad ( 1 - 1 a )$$

$${u}^{b} ( x , y ; {x}^{b} , y \text{?} , \text{?} ) = {\sum }_{n}^{n = N} {𝒩}_{a} ( x , y ; x \text{?} , y \text{?} , \text{?} ) {u}_{n} \qquad ( 1 - 1 b )$$

$$\text{?} \text{indicates text missing or illegible when filed}$$

where uh is the displacement field, x* and y* are the vector used to save the nodal positions, N is the total number of nodes, uₙ and Nₙ (x, y; x*ₙ, y*ₙ, A) denote the nodal displacement and interpolation function at node n. σ and ε are the stress and strain tensors, respectively, f is the body force, and t is the external traction applied to boundary Γt. For linear elastic problem,

$$\text{?} = \frac{1}{2} ( ∇ u \text{?} + ( ∇ u \text{?} ) \text{?} ) .$$

$$\text{?} \text{indicates text missing or illegible when filed}$$

Note that to avoid the inverted elements when the nodes are moved during training, a stop criterion for detecting a jump of the loss function is added. Inversion of an element will cause the loss function will increase suddenly, at which point the training will be stopped and the previous iteration will be taken as the final result.

$$\text{?} = \vert \frac{{ℒ}_{n + 1} - {ℒ}_{n}}{{ℒ}_{n}} \vert \qquad ( 1 - 2 )$$

$$\text{?} \text{indicates text missing or illegible when filed}$$

where e_{L} denotes the change of the loss function between the neighbor iterations. When e_{L}>0.2, the training is stopped and the previous iteration is taken as the results.

To assess the method, we compare the computational cost of HiDeNN with the standard FEM. To do this, we fix the nodal positions during optimization similar to standard FEM. Under such conditions, HiDeNN solves a problem by minimizing a loss function, which is the potential energy of the structure for a mechanics problem, using a state-of-the-art optimizer (i.e. the Adam method) available in most deep learning software packages. FIG. 25 illustrates schematic diagram of the test problem, a square domain with four initial elliptical voids. The dimensions of the square domain are 2×2. Young's modulus of the material is 105 and Poisson's ratio is 0.3. The left side of the domain is fixed while a uniform load of F=20 is applied to the right-side of the domain.

The test problem is an elastic material under simple tensile loading with four initial elliptical voids, solved under the plane stress condition. The domain of the test problem is a square with dimensions 2 by 2 The displacement of left side of the domain is fixed while a uniform loading of F=20 is applied to the right side along the +x-direction. Young's modulus, E of the elastic material is 10⁵, and the Poisson's ratio, v, is 0.3. The domain is discretized by conformal mesh with differing numbers of quadrilateral elements using Abaqus. We consider several conformal meshes with an increasing number of degrees of freedom: 1154, 2022, 4646, 8650, 16 612, 33 340, 65 430, 130 300, 259 430, 1 236 948 and 2 334 596

First, we solve the problem using Abaqus and the displacements at each node are later used as the reference for estimating the HiDeNN solution. Here, the ∥e∥_{L1} error of the displacement defined in Eq. (1-3) is used for estimation. If ∥e∥_{L1}<10⁻⁶, the HiDeNN computations are considered to be finished.

$$‖ e ‖ \text{?} = \frac{{\sum }_{i = 1}^{u} \vert {u}_{i}^{Abaqus} - {u}_{i}^{HiDeNN} \vert}{{\sum }_{i = 1}^{n} \vert {u}_{I}^{Abaqus} \vert} , \qquad ( 1 - 3 )$$

$$\text{?} \text{indicates text missing or illegible when filed}$$

u_{f}^{Abaqus} is the displacement at node I obtained by Abaqus, while is the corresponding value obtained uₗ^{HiDeNN} is the corresponding value obtained by HiDeNN method. I is the index for the nodes in the domain, and n denotes the total number of nodes within the domain. The computational time of HiDENN with respect to the degrees of freedom (DOFs) is plotted on logarithmic axes in FIG. 26. FIG. 26 shows computational iterations and time of HiDeNN with respect to the number of degrees of freedom. Computational time increases slightly faster than the degrees of freedom. (a) Iteration number versus degrees of freedom, (b) Computational time versus degrees of freedom. As can be seen, the computational cost of HiDeNN increases with the degrees of freedom (DOFs).

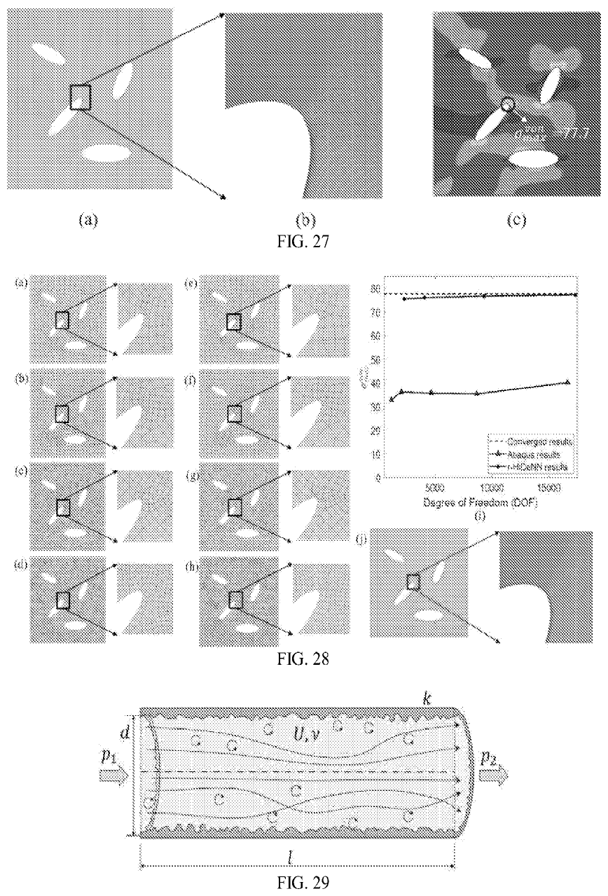

It has an approximately linear relationship with the DOFs on the log-log plot with slope slightly larger than 1. This implies that computational cost increases more quickly than the number of degrees of freedom. In order to show how the HiDeNN can “intelligently” capture the stress concentrations, we relax the nodal position constraints in the neural network and train the nodal positions and nodal displacements simultaneously. For comparison, a convergence study for the maximum local stress is conducted in Abaqus with a convergence criterion of less than 1% of change between two cosecutively more refined meshes. The converged mesh is taken as the reference solution to examine the performance of the HiDeNN. The converged mesh and the stress distributions are given in FIG. 27, panels (a), (b), and (c), respectively. FIG. 27 shows converged conformal mesh and the corresponding FEM results (von Mises stress) for the test problem with four elliptical holes. (a) Full domain with four elliptical holes, (b) detail of the converged mesh near the stress concentration, (c) stress distribution inside the full domain for the converged solution in Abaqus. The maximum local stress within the test geometry converges to 77.7 for a mesh with 3 867 168 quadrilateral elements and 7 748 156 DOFs. As illustrated in the FIG. 27, the maximum local stress occurs near the top corner of the bottom left ellipse. In order to capture the stress peak, an extremely fine mesh is required at this region when using standard FEM, accoridng to FIG. 27, panel (b).

For a one-to-one comparison between the FEM and HiDeNN solutions, the test problem is discretized with same conformal meshes as Abaqus. Four meshes are used, with 524 quadrilateral clements with 1154 DOFs, 938 quadrilateral elements with 2022 DOFs, 2194 quadrilateral elements with 4646 DOFs, and 4143 quadrilateral elements with 8650 DOFs, as shown in FIG. 28, panels (e)-(h). FIG. 28 shows comparison of the discretization between Abaqus and the HiDeNN for stress concentration regions after learning the nodal positions. Conformal mesh from Abaqus with (a) 1154 DOFs, (b) 2022 DOFs, (c) 4646 DOFs, (d) 8650 DOFs. Conformal mesh from HiDENN with (c) 1154 DOFs, (f) 4044 DOFs, (g) 9292 DOFs, (h) 17 300 DOFs. (i) Maximum von Mises stress versus number of elements, (j) conformal mesh from converged solution with 7,748,156 DOFs. Both HiDENN and FEM are applied to these four meshes and compared against converged solution for maximum stress.

The maximum computed stresses from FEM and HiDENN, and their differences from the converged, conforming mesh solution are tabulated in Table 1-1. For FEM, due to the inherent complexity for generating a conformal mesh to capture stress concentrations for ellipses, the predicted values from coarse mesh are still lower than the converged stresses (57.92%, 53.41%, 54.05%, and 54.44% lower for four cases). On the other hand, the results obtained by HiDeNN show much better accuracy through learning the optimal nodal positions. As shown in FIG. 39, HiDeNN moves the nodes during training to the regions with stress concentrations. Even with the coarsest discretization, 524 quadrilateral elements and 938 quadrilateral elements, HiDeNN is able to capture the maximum stress well, with about 2.70% and 2.06% difference from the converged value. We also compare the computational time with the HiDeNN method with the converged results. For the same accuracy for maximum stress, the HiDeNN method with moving nodes takes 17.53 s, 22.87 s, 31.09 s and 40.25 s while Abaqus takes about 1334.37 s. FIG. 28 panel (i) presents the maximum von Mises stress obtained by both Abaqus and HiDeNN method with plotted against the number of elements in the mesh. When using the same coarse mesh, HiDeNN is able to precisely capture the stress concentration by moving the nodes to the maximum stress region. Note that the computational time for both HiDeNN and Abaqus is based on calculations conducted on a CPU. The performance of HiDeNN even with a coarse discretization demonstrates the potential for HiDeNN to bypass computationally expensive conformal mesh generation for complex geometry and reduce the expensive computational cost of capturing the stress concentration with conforming meshes. In concept, this is similar to isogeometric analysis (IGA), in that the difficulty of mesh generation is mitigated.

TABLE 1-1
Summary of difference in maximum von Mises stress between the HiDeNN 2D solutions
(with an initially uniform mesh) and the conforming mesh solution from FEM.

| | | Degrees | | | CPU-based |
|---|---|---|---|---|---|
| | Number of | of freedom | σ νon | | computational |
| Type of analysis | elements | (DOFs) | max | Difference | time (s) |
| Abaqus | 3 867 168 | 7 748 156 | 77.7 | — | 1334.37 |
| (reference | | | | | |
| solution) | | | | | |
| Abaqus | 524 | 1154 | 32.7 | 57.92% | — |
| r-HiDeNN | 524 | 2308 | 75.6 | 2.70% | 17.53 |
| Abaqus | 938 | 2022 | 36.2 | 53.41% | — |
| r-HiDeNN | 938 | 4044 | 76.1 | 2.06% | 22.87 |
| Abaqus | 2194 | 4646 | 35.7 | 54.05% | — |
| r-HiDeNN | 2194 | 9292 | 76.8 | 1.16% | 31.09 |
| Abaqus | 4143 | 8650 | 35.4 | 54.44% | — |
| r-HiDeNN | 4143 | 17 300 | 77.3 | 0.51% | 40.25 |

### 3.2. HiDeNN for Multiscale Analysis

This example shows that multiscale analysis can be conducted with HiDeNN by augmenting it with a sub-neural network. In the case of a fiber-reinforced composite, the variation of fiber volume fraction leads to variable material properties throughout the composite part. To account for this effect, multiscale analysis can be used to capture local microstructure. The present invetion examines the capability of HiDeNN to conduct multiscale analysis in the following sample multiscale problem. Detailed multiscale analysis is presented in Liu, Zeliang, M. A. Bessa, and Wing Kam Liu. “Self-consistent clustering analysis: an efficient multi-scale scheme for inelastic heterogeneous materials.” Computer Methods in Applied Mechanics and Engineering 306 (2016): 319-341, which is hereby incorporated by referecne in its entirety.

3.3. HiDeNN for Multivariate System: Discovery of Governing Dimensionless Numbers from Data

The HiDeNN can handle data in a high-dimensional parametric space, p₁˜pₙ as shown in FIG. 22. However, a large number of input parameters often causes two severe problems: first, the number of data required for training the network exponentially increases with the dimensionality of the inputs, i.e., the curse of dimensionality; second, a large number of parametric inputs with complex dependencies and interactions could significantly degrade the capability of extrapolation and prediction of the network. In order to reduce the dimensionality of the input parameters such that HiDeNN can be applied to a wide range of science and engineering problems, we propose a dimensionally invariant deep network (DimensionNet) embedded in the HiDeNN. The

DimensionNet reduces the dimensionality of the original input parameters by automatically discovering a smaller set of governing dimensionless numbers and transforming the high-dimensional inputs to the dimensionless set. The DimensionNet can identify appropriate pre-processing functions and parameter layers for HiDeNN.

To illustrate the performance and features of the proposed DimensionNet, it is used to “rediscover” well-known dimensionless numbers, e.g., Reynolds number (Re) and relative roughness (Ra*), in a classical fluid mechanics problem: laminar to turbulent transition in rough pipes. We use the experimental data collected by Nikuradse to demonstrate that the proposed DimensionNet can recreate the classical governing dimensionless numbers and scaling law.

A schematic of turbulent pipe flow is presented in FIG. 29. In particular, schematic of the fluid flow in a rough pipe with dimensional quantities, including inlet pressure p1, outlet pressure p2, pipe diameter d, pipe length l, average steady-state velocity U, kinematic viscosity ν, and surface roughness Ra. The dependent parameter of interest is the dimensionless resistance factorλ that can be expressed as:

$$λ = \frac{{p}_{1} - {p}_{2}}{\text{?}} \frac{2 d}{ρ {U}^{2}} , \qquad ( 1 - 4 )$$

$$\text{?} \text{indicates text missing or illegible when filed}$$

where p₁−p₂ represents the pressure drop from inlet to outlet, l is the length of the pipe, d is the diameter of the circular pipe, ρ is the density of fluid and U measures the average velocity over a steady-state, i.e., fully-developed, section of the pipe.

The present invention postulates that the resistance factor λ depends on four parameters: the steady-state velocity of fluid U, kinematic viscosity ν, pipe diameter d, and surface roughness of the pipe Ra: λ=f (U, ν, d, Ra).

It is assumed that there are only two governing dimensionless parameters in this system (the maximum number of the governing dimensionless parameters can be determined by dimensional analysis). To discover these two dimensionless combinations from the dataset, we take the experimental data with various U, ν, d, Ra as the four inputs of the DimensionNet, and log(100λ) as the output to be consistent with the original results,

[symbol]

(1-5)

[symbol]

(1-6)

where p is the dimensional parametric input and u is a solution as shown in FIG. 22, the subscript n denotes the nth data point and runs from 1 to N, which is the total number of the data points. The 448 data points used are divided into 359 the training set for training the parameters of regression models and 89 test set for evaluating the performance of the models.

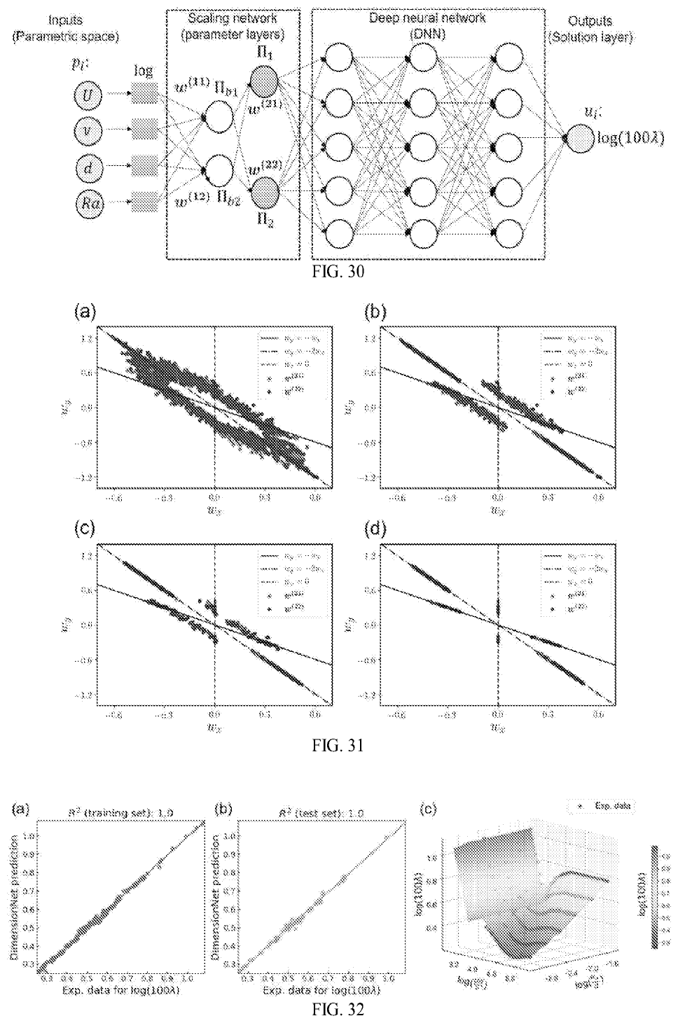

A schematic of DimensionNet is shown in FIG. 30. The proposed DimensionNet includes two parts:
A scaling network used to discover explicit form of hidden dimensionless number(s). The scaling network corresponds to the parameter layers in FIG. 22.
A deep feedforward network represents nonlinear correlations, i.e., similarity function, between the dimen-sionless numbers. The deep network corresponds to the PHY-NN or EXP-NN in FIG. 22.

As shown in FIG. 30, the first layer of the scaling network constructs several dimensionless parameters, Π_{bj}, as a set of basis via weights ω^{(1 j)} as (there is no bias used in the scaling network)

$${\prod }_{bj} = {\sum }_{i} {w}_{i}^{( {1}_{j} )} log ( {p}_{i} ) = log ( {\prod }_{i} p \text{?} ) \qquad ( 1 - 5 )$$

$$\text{?} \text{indicates text missing or illegible when filed}$$

FIG. 30 shows a schematic of the dimensionally invariant deep network (DimensionNet). The four inputs are p1=U, p2=ν, p3=d, and p4=Ra. The output is u=log(100λ). The number of neurons at each layers depends on the applied problem. The network structure presented in this FIG. 30 is just for illustration.

The weights of the first layer ω^{(1 j)} can be predetermined from the dimensional matrix B, in which the rows are the dimensions and the columns are the input parameters. For example, the dimensional matrix B for the pipe flow problem is expressed as

$$\begin{matrix}υ & \text{?} & d & \text{?}\end{matrix} \\ B = \begin{matrix}[ \text{?} ] \\ [ \text{?} ]\end{matrix} [ \begin{matrix}1 & 2 & 1 & 1 \\ - 1 & - 1 & 0 & 0\end{matrix} ]$$

$$\text{?} \text{indicates text missing or illegible when filed}$$

where [L] and [T] are fundamental dimension: length and time, respectively.

To make sure the Π_{bj} are dimensionless, the weights of the first layer should satisfy

B ω^{(1 j)}=0 (1-8)

There are infinitely many vectors that yield this condition, and actually they span a two-dimensional space (in this example). We arbitrarily choose two of them as basis vectors of this two-dimensional space and they are the weights of the first layer of the DimensionNet,

ω⁽¹¹⁾=[1 −1 0 1]^{T} (1-9)

ω⁽¹²⁾=[2 −2 1 1]^{T} (1-10)

The set of dimensionless basis, Π_{bj}, then create new dimensionless parameters at the second layer via weights ω^{(2 j)} by

$${\prod }_{j} = {\sum }_{i} w \text{?} log ( \prod \text{?} ) = log ( {\prod }_{i} \text{?} ) \qquad ( 1 - 11 )$$

$$\text{?} \text{indicates text missing or illegible when filed}$$

Since the invention uses linear activation function in scaling network, the scaling weights, ω(1) and ω(2), can be defined by linearly combining weights from the first and second layers:

ω⁽¹⁾=[ω⁽¹¹⁾ω⁽¹²⁾]ω⁽²¹⁾ (1-12)

ω⁽²⁾=[ω⁽¹¹⁾ω⁽¹²⁾]ω⁽²²⁾ (1-13)

Thus, the dimensionless parameters Πⱼ can be represented by inputs, p, and scaling weights, ω^{(j)}, as

$$\text{?} = log ( {\prod }_{i} \text{?} ) \qquad ( 1 - 14 )$$

$$\text{?} \text{indicates text missing or illegible when filed}$$

The deep feedforward network maps the Πⱼ to the dependent output u. Any inherent nonlinear relationship f(·) can be captured since the universal approximation capability of deep neural networks. The output of the DimensionNet can be expressed as

$$log ( 100 λ ) = f ( log ( \text{?} ) \text{?} log ( \text{?} ) ) = f ( log ( \text{?} ) \text{?} log ( \text{?} ) ) \qquad ( 1 - 15 )$$

$$\text{?} \text{indicates text missing or illegible when filed}$$

Two objectives can be achieved by training the DimensionNet: first, identify the weights of the second layer ω^{(2j)} such that the expression of the hidden dimensionless parameters Πⱼ can be quantified by Eq. (1-11); and second, train the weights and biases in the deep neural network (DNN) to represent the nonlinear function f(·) such that the difference between the network output and the dependent parameters of interests is minimized. The proposed loss function of the DimensionNet is

$$= \frac{1}{N} {‖ u - \hat{u} ‖}_{2}^{2} + {β}_{1} ‖ {w}^{( 1 )} \text{?} + {β}_{2} ‖ {w}^{( 2 )} \text{?} \qquad ( 1 - 16 )$$

$$\text{?} \text{indicates text missing or illegible when filed}$$

where the first term indicates the mean square error (MSE), N is the number of training data points, u is the output vector of the DimensionNet including [symbol] , û is the corresponding measurements of the dependent parameters. The second and third terms indicate the L1 norm of the scaling weights of the scaling network, and β1 and β2 are hyper-parameters that determine the relative weighting of the three terms in the loss function. The loss function encourages the DimensionNet to minimize the MSE error and to use the minimal number of input parameters for the representation of data.

The DimensionNet is trained using the Adam optimizer. Weights of the scaling network are randomly initialized between −1 and 1 before training. In addition to the loss function weightings (β1=β2=5.0×10⁻⁴ in this case), there are several other hyper-parameters including learning rate (3.0×10⁻³), decay rate (0.3), decay step (100), the number of epochs (400), and the number of dimensionless parameters (2). For the deep feedforward network, we use 4 fully-connected layers (10 neurons) with biases and Rectified Linear Unit (ReLU) activation functions. The choice of hyper-parameters affects the accuracy and efficiency of the method. In this study, we determined those hyper-parameters by trial and error, based on our experience. Optimization of the hyper-parameters for data-driven models is a very important topic. Bayesian optimization is a promising method to determine those hyper-parameters. We save 16 709 snapshot results and get 3968 points which have high R² (greater than or equal to 0.98). Then we use the Bayesian information criterion (BIC) to select the parsimonious model that has the best predictive capability but with the minimal non-zero parameters. The expression of the BIC used in this study is

[symbol]

(1-17)

where N is the number of data points used in training or testing procedure, e is the residual represented by ϵ=u−u\hat{ }, δϵ2 is the variance of the residuals, and k is the number of non-zero components of the scaling weights, i.e., w(1) and w(2). It is noted that in order to enhance the effect of the number of parameters we use ek rather than k in the original BIC expression.

Out the optimal combinations of dimensional inputs, the results of identified weights at the second layer, i.e., ω⁽²¹⁾ and ω⁽²²⁾ are shown in FIG. 31 The x and y axes indicate the first and second components of a weight, respectively. FIG. 31, panels (a)-(d) presents the selected results with different training BIC thresholds. It is noted that smaller BIC means that the model has better balance between accuracy (R²) and complexity (the number of non-zero parameters). The results in FIG. 31, panel (d) show the parsimonious models with the smallest BIC. As shown in FIG. 31, panel (d), most of the scaling weights converge to two lines: ω_{y}=−ωₓ and ω_{y}=−2ωₓ. Thus, based on Eq. (1-11) the governing dimensionless numbers have the form,

$$\text{?} = log ( \frac{Ud}{v} ) \qquad ( 1 - 18 )$$

$$\text{?} = log ( \frac{Ra}{d} ) , \qquad ( 1 - 19 )$$

$$\text{?} \text{indicates text missing or illegible when filed}$$

Interestingly, the dimensionless numbers identified with the DimensionNet from data perfectly match those discovered “manually” in the 1950s (The log function in Eqs. (1-18) and (1-19) can be vanished by using exponential activation functions for the neurons at the second layer of the scaling network). They are the well-known Reynolds number and relative surface roughness

$$Re = \frac{Ud}{v} \qquad ( 1 - 20 )$$

$$R \text{?} = \frac{R \text{?}}{d} \qquad ( 1 - 21 )$$

$$\text{?} \text{indicates text missing or illegible when filed}$$

The scaling law or similarity function captured by the DimensionNet can be expressed as

$$( 1 - 22 )$$

$$log ( 100 λ ) = f ( log ( \frac{Ud}{v} ) \text{?} log ( \frac{Ra}{d} ) ) = f ( log ( Re ) \text{?} log ( R \text{?} ) )$$

$$\text{?} \text{indicates text missing or illegible when filed}$$

FIG. 32 shows a comparison between experimental data and DimensionNet prediction: (a) R2 for the training dataset; (b) R2 for the test dataset; and (c) captured relationship between identified dimensionless numbers and resistance factor. The points represent experimental data and the surface represents the DimensionNet result. The coefficients of determination R2 are shown in panel (a) of FIG. 32 for the training set and panel (b) of FIG. 32 for test set. The R2 values are nearly 1, indicating the good predictive capability of the DimensionNet. Panel (c) of FIG. 32 shows the two-dimensional pattern hidden in the original four-dimensional parametric space, and this low-dimensional pattern is governed by two identified dimensionless numbers, i.e., Reynolds number Re and relative roughness Ra*. In this study, we assume the number of governing dimensionless parameters is known, but it does not have to be known for a general problem. If we do not know the number of dimensionless parameters, we would start at one and train the DimensionNet and see if the network can converge to a highly accurate result. If so, we conclude that there is only one governing dimensionless number in the problem. If not, we will set up one more dimensionless parameter and re-train the DimensionNet. We will repeat this procedure until we find a converged result. In this way, we can identify the number of governing dimensionless number for a problem or a system without governing equations.

Traditionally, the dimensionless numbers are identified by dimensional analysis or from normalized governing equations. However, for many complex systems the optimal dimensionless numbers cannot be determined by using dimensional analysis alone, and for many applications we do not have well-tested governing equations of the problems or only know part of them. For those problems, we can alternatively use the proposed DimensionNet to discover the governing dimensionless numbers purely from data. The identified smaller set of dimensionless numbers informs HiDeNN such that it can predict more complex behaviors of the problems in a more accurate and efficient manner. The DimensionNet involves the principle of the similitude and dimensional invariance. It can eliminate the physically inherent dependency between the dimensional input parameters without any loss of accuracy, and thus has better extrapolation capability than traditional dimensionality reduction method such as principal component analysis (PCA).

The proposed DimensionNet is a very general tool and thus can be applied to many other physical, chemical and biological problems where abundant data are available but complete governing laws and equations are vague. The identified reduced parameter list can be used as the input to the HiDeNN. It can significantly improve the efficiency and interpretability of the network and avoid overfitting by reducing the input space and dependency.

### 4. Extension of HiDeNN to Solve Challenging Problems

This section demonstrates a typical AI solution method for one example of each type of the challenging problems introduced in Section 1, and make note of challenges with these existing methods that might be mitigated by using HiDeNN.

### 4.1. Type 1: Purely Data-Driven Problems

The case study involves finding the salient relationship between the local thermal history and ultimate tensile strength in a thin wall built by direct energy deposition with Inconel 718 alloy. In this case, we assume there is no known physical law connecting these two factors; thus, an AI/ML method is used to infer the relationship.

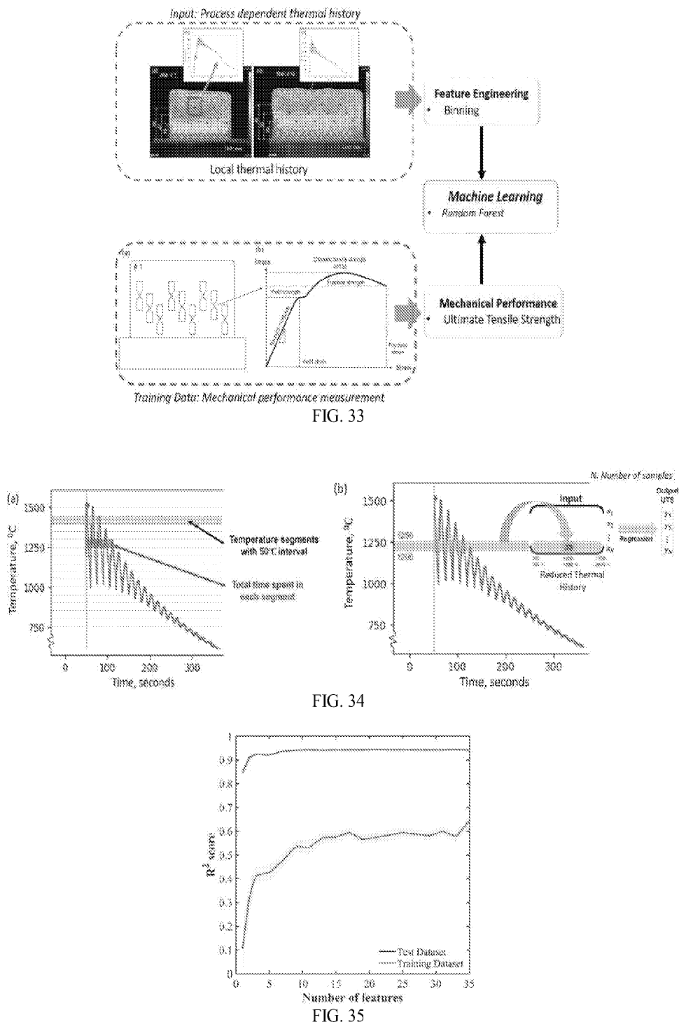

FIG. 33 shows the framework used in this example. Infrared (IR) imaging records the thermal history for cach point in an AM built thin wall. A total of 12 such walls are considered for the study cach having 120 layers with 0.5 mm layer height. A total of 135 temperature-time histories and corresponding ultimate tensile strength are accumulated as samples.

Because of the high dimensional nature of collected thermal histories, a binning technique for dimension reduction is applied as shown in FIG. 34, panel (a). The total temperature range from the first peak to the end from all the collected samples are divided into bins of 50° C. and time spent (in seconds) in all those bins are considered as features. In this way, the continuous thermal histories are converted into an N×M matrix where N is the number of samples and M is the number of total bins (see FIG. 34(b)). The corresponding ultimate tensile strength of the AM parts are collated into a N×1 vector. Using the binned data, a Random Forest (RF) regression supervised machine learning is used to link the reduced thermal history with mechanical performance. The coefficient of determination R2 with 95% confidence interval for both training and testing data (split as 80% training-20% testing) are shown in FIG. 35. Increasing the number of considered features (number of bins in the input matrix), tends to increase the R2 both in training and testing. Thirty five features completely describe all the thermal histories in the sample. The training time for the random forest algorithm is 0.18 s on a 2.3 GHZ Intel Core i5 processor.

Although this AI approach can capture very complex relationships between temperature history and ultimate tensile strength in AM, our model overfits the data as indicated by the difference of R2 between training and test datasets as shown in FIG. 35. Hence, an alternative dimension reduction or regression method is required. With no prior knowledge it is hard to decide which AI tool or technique should be chosen.

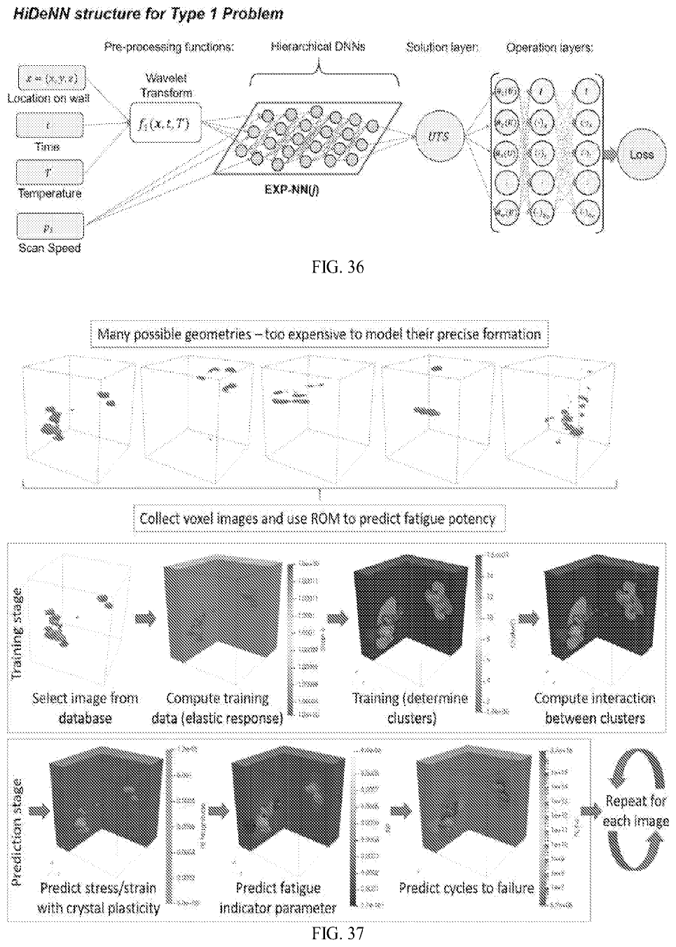

We can use the HiDeNN framework to solve this problem and obtain insight on the governing physics as shown in FIG. 36. To solve this example, the HiDeNN will consist of input layer (location, time, temperature, and manufacturing process parameter (such as scan speed) as inputs), pre-processing functions, EXP-NN layer, solution layer, and operation layers. If we look back to Section 2, spatial location is Ω, processing history is t, and manufacturing conditions are p. The pre-processing function can be designed so that high-dimensional thermal history data at different locations on the wall becomes tractable for learning algorithms. A candidate function for this operation can be continuous wavelet transformation function. The combination of solution and operation layers will discover unknown physics relating thermal history and mechanical property in AM built wall. The loss function can be defined as,

$$( 1 - 23 )$$

$$= \frac{1}{{N}_{T}} \text{?} {( {UTS}_{exp} - {UTS}_{i} )}^{2} + λ {‖ P ( x , t , T , {UTS}_{exp} ) - θ ( x , t , T , {UTS}_{exp} ) ‖}_{2}$$

$$\text{?} \text{indicates text missing or illegible when filed}$$

where, L is the loss function, N_{T} is the number training samples, UTSₑₓₚ is the ultimate tensile strength from experimental observations, UTSi is the predicted ultimate tensile strength from the HiDENN, λ is the Lagrange multiplier, P(x, t, T, UTSₑₓₚ) is a function of operators and expressions such as addition, multiplication, differentiation, or integration, θ(x, t, T, UTSₑₓₚ) is a function of position (location on the wall), time, and temperature, and ∥·∥₂ is the L₂ norm. The first term of Eq. (1-23) comes from the hierarchical DNN layer while the second term comes from the operations layer. Combined minimization of these two terms with the Lagrange multiplier for the latter one will give us a mathematical expression for the relationship between spatiotemporal co-ordinates, temperature, and ultimate tensile strength, revealing unknown physics. One concern is that the experimental data contain noise and uncertainty. In order to tackle this problem the hierarchical DNN layer can be a Bayesian neural network resulting in probabilistic terms in the mathematical expression. This will be a part of our future research on HiDeNN.
4.2. Type 2: Mechanistically Insufficient Problems with Limited Data

Type 2 problems are problems for which the available physical information is incomplete. For example, the governing equations may be known, but all the parameters in the governing equations are not explicitly identified. To illustrate, we present here how fatigue life of an AM part can be predicted from statistical information about microstructures with porosity. In this case, we know the governing physics of the problem on the continuum scale but there is limited data relating microstructural porosity and process parameters, and the spread in fatigue life is quite large making empirical fatigue predictions inaccurate. By incorporating experimental images directly higher simulation fidelity is achieved, with the trade-off of higher computational expense. To predict fatigue response a computational crystal plasticity material law is used, which predicts the local cyclic change in plastic shear strain (denoted Δγ^{p}). This cyclic change saturates relatively quickly (up to 10 cycles may be needed, but in this case after about 3 or 4 cycles), and the saturated value is used as input to a microstructurally relevant Fatemi-Socie-type fatigue indicator parameter (FIP) for high cycle fatigue. The FIP can be calibrated to fatigue life using, e.g., reference experimental data for the material of interest.

The crystal plasticity and FIP methods have been implemented in already explained Self-consistent Clustering Analysis (SCA) with crystal plasticity material law (termed CPSCA, as described in previous works). Example images, a schematic of the solution method, and the resulting prediction of number of incubation cycles for an example microstructure from various possible images is shown in FIG. 37. For this model there are 16 clusters in the matrix phase and 4 in the void phase, selected to balance accuracy and computation cost based on prior experience with similar systems. Constructing the “offline” data for each image in the SCA database cost about 200 s but need only be run once to provide a complete training set for all possible boundary conditions for that image using an implementation of the FFT-based elastic analysis in Fortran. The “online” part of SCA took about 15 or 20 s per loading condition per microstructure image to compute fatigue crack incubation life, Ninc, using crystal plasticity. While a comparison to an DNS solution with crystal plasticity has not been conducted for this case , this represents about a factor of about two speed up even when comparing an elastic analysis with DNS versus a full crystal plasticity analysis with the online SCA method for one loading condition. The more loading conditions required, the more favorable this comparison becomes for SCA as no re-training is required after the initial “offline” data is generated. The loading conditions shown are approximately uniaxial tension/compression in the vertical axis (extracted from a multiscale simulation, so uniaxiality is not fully guaranteed), specified via applied deformation gradient in each voxel. The resulting information can be used as training data for the HiDeNN, as shown mathematically in the loss function given in Eq. (1-24).

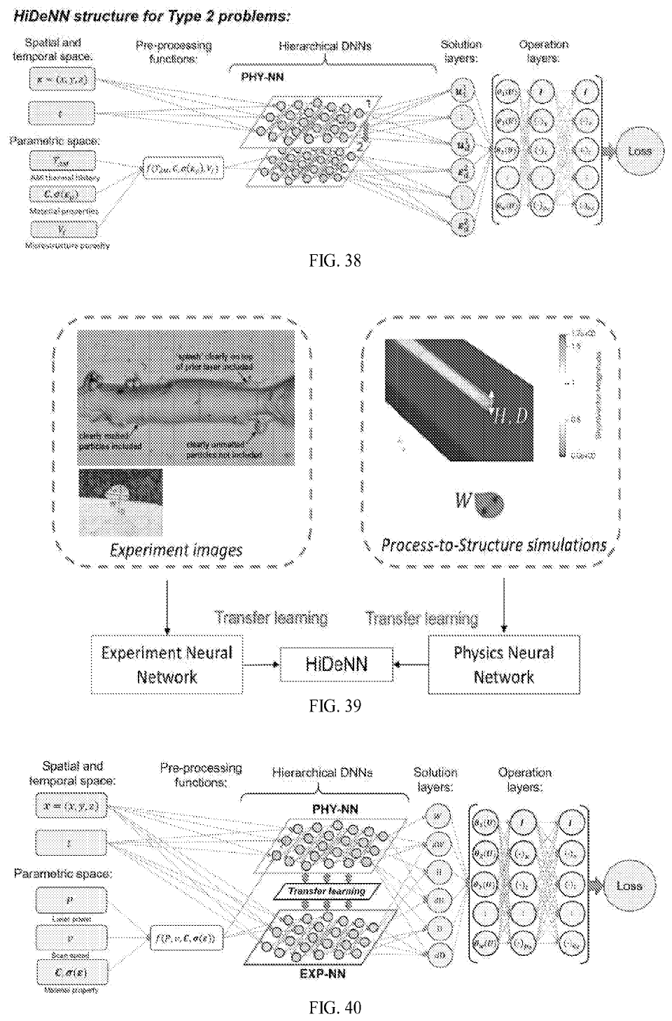

For this example, HiDENN could be applied to construct a relationship between the process, experimental microstructural images, and material performance. The relationship can be regarded as a new material performance prediction formulation, where microstructural features can be directly considered by using a deep convolutional neural network (CNN) as the NN within HiDeNN for image feature identification. A proposed framework for solving this problem is shown in FIG. 38. For an AM build, the x and t can be location and process history. In the parametric input, we can consider the process parameters, basic material properties, and images of porosity (and potentially other microstructural features). The pre-processing functions are employed to prepare the 3D images for the CNN. The solution layer contains the fatigue life and the mechanical response of the RVE. The operation layer is designed to construct the loss function as,

$$( \text{?} ) = {( 1 )}^{} + {( 3 )}^{} = \frac{1}{2} \text{?} ( \text{?} ) \text{?} ( \text{?} ) d Ω - ( \text{?} {u}^{k} \cdot fd Ω + \text{?} {u}^{k} \cdot \text{?} d Γ ) scale 1 + \text{?} {( \text{?} ( \text{?} - \text{?} ) )}^{2} scale 2 \qquad ( 1 - 24 )$$

$$\text{?} \text{indicates text missing or illegible when filed}$$

where u^{h} is displacement history, ε is the applied strain history, N^{H}_{inc} is the fatigue crack incubation life computed from the HiDeNN and N_{inc} is the fatigue incubation life computed from CPSCA, L⁽¹⁾ is the macroscale loss function (scale 1), L⁽²⁾ is the microscale loss function (scale 2).

Another approach to solve type 2 problems is using transfer learning to combine the experimental and simulation data. Transfer learning refers to taking a pre-trained machine learning model and extending it to new circumstances combining experimental and computational data. These pre-trained models can be trained by experimental data and improved by combining simulation data or vice versa. It is an effective and efficient solution because experimental data come from a more realistic source but harder to get and simulation data can be easily generated but suffer from simplified assumptions in physics. By fusing the models with transfer learning, the HiDENN can leverage small amount of experimental data to compensate for the lack of knowledge in physics coming from computational data.

One example of such a problem is the prediction of the melt pool dimensions in metal additive manufacturing . The melt pool dimension can be predicted from computational models. However, these models fail to capture the uncertainties coming from process parameters, spatial distribution of powder particles and corresponding instantaneous change in the melt pool dimension. FIG. 39 presents a schematic of the problem. A single track sample (printed using an EOS M280 Laser Powder Bed Fusion (L-PBF) system) of commercially available Inconel 625 gas atomized powder is shown in the FIG. 39. For the melted track geometry, W is defined as the width of cross-sectioned track at the substrate plane, Wₘ is maximum width (the widest section of melted track), H is the height (highest point from the substrate plane), and D is the depth (deepest point from the substrate planc). For experimental measurement, the W, H, and D have variances dW, dH, and dD, respectively, caused by uncertainties. For the simulation, An effective medium CFD model is used to predict W, H, and D. As discussed before, in simulation it is hard to consider all the uncertainties in manufacturing procedure. The experiment model and physics model will be combined together through transfer learning to make accurate predictions.

FIG. 40 shows the HiDENN structure for this problem. The inputs are the coordinates and time in spatial and temporal space. For the parametric space, P refers to the laser power, v refers to the scan speed, and C, and σ(ε) refer to the material properties. The pre-processing functions are used to extract features from experimental data such as images of the melt pool. The hierarchical DNNs have PHY-NN and EXP-NN combined by transfer learning. The operation layers are used to define the loss function. Several algorithms can be used to train the model, such as Kernel-Mean Matching (KMM):

$$\text{?} \frac{1}{2} {β}^{T} K β - {κ}^{T} β \qquad ( 1 - 25 )$$

$$s . t . \text{?} ∈ [ 0 , \text{?} ] and \vert \text{?} - \text{?} \vert \leq n \text{?}$$

$$\text{?} \text{indicates text missing or illegible when filed}$$

The probability ratio between source domain and target domain is defined as β. The task of transfer learning is to find the ratio β, with the aim to eliminate the discrepancy in different models. In the above equations, K is the kernel matrix for the source domain data and the target domain data. Number of source samples is ns and number of test samples is n_{T}. By solving the above equations, the EXP-NN and PHY-NN are fused together to a predictive HiDeNN model. The authors are further exploring the topic and more details will be included in future works.

### 4.3. Type 3: Computationally Expensive Problem

For Type 3 problems, systems with known physics are solved efficiently using SCA to predict material response with nonlinear behaviors. SCA can be used to provide fast and accurate data for implementing Reduced Order Model (ROM).

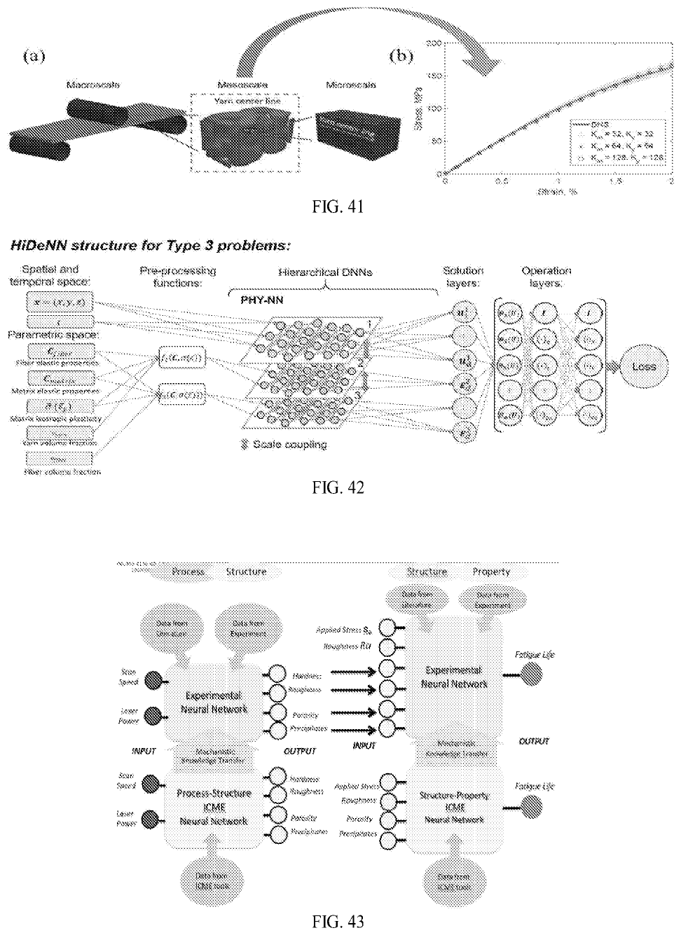

Consider the 3D braided composite laminate for 3-pt bending model (macroscale) shown in panel (a) of FIG. 41. At each integration point in the macroscale, a high fidelity Representative Volume Element (RVE) for the 3D braided mesoscale structure is applied to compute material responses, as shown in the middle of panel (a) of FIG. 41. The 3D braided RVE yarn responses are computed directly using a microscale unidirectional (UD) RVE, where the UD RVE fibers align with the yarn center line, as depicted in panel (a) of FIG. 41. In a 3-scale modeling, mesoscale, and microscale structures should be solved using SCA to ensure computational efficiency. For illustration purpose, only the mesoscale structure is studied in this embodiment to reveal the significant saving in computational cost by SCA. The mesoscale RVE, shown in panel (a) of FIG. 41 with dashed green box, contains two phases: matrix and yarn. The matrix property is based on the data, assuming isotropic clasto-plastic material response. The yarn is assumed to be transversely isotropic elastic, where the stiffness matrix is computed through computational homogenization of a UD RVE with fiber volume fraction of 51%. The 3D braided RVE, originally containing 212,500 voxel elements, is compressed into three sets of ROM. Each ROM contains different numbers of cluster for the matrix (Kₘ) and yarn (K_{y}) phases. Case 1 contains, Kₘ=K_{y}=32; case 2 has Kₘ=K_{y}=64, and case 3 contains Kₘ=K_{y}=128. The time for offline calculation is 109.3 s for case 1, 379.2 s for case 2, and 1398.2 s for case 4. The ROM predictions of the uniaxial transverse tensile test responses are compared against direct RVE prediction, achieving a 5% difference as shown in FIG. 41(b) with a maximum speed-up of 446,896 for the Kₘ=K_{y}=32 case.

For this problem, HiDeNN could be applied to convert the 3-scale multiscale model depicted in panel (a) of FIG. 41 into the HiDeNN formulation. The possible HiDeNN formulation of the multiscale problem is illustrated in FIG. 42. The associated loss function to FIG. 42 that couples macroscale (scale 1), mesoscale (scale 2), and microscale (scale 3), is shown in Eq. (1-26). Note that for practical implementation, three loss functions representing three distinct scales can be solved separately, and coupled together though scale coupling for information exchange, as shown in FIG. 42.

$$( {u}^{h} \text{?} {λ}^{( 2 )} \text{?} {λ}^{( 3 )} ) = {1}^{} + {λ}^{( 2 )} {( 2 )}^{} ++ {λ}^{( 3 )} {( 3 )}^{} = \frac{1}{2} \text{?} ( {u}^{h} ) \text{?} ( {u}^{h} ) d Ω - ( {\int }_{Ω} {u}^{h} \cdot fd Ω + \text{?} {u}^{h} \cdot \text{?} d Γ ) scale 1 + {λ}^{( 2 )} ( \text{?} {\vert \text{?} ( x ) + \text{?} [ \text{?} - \text{?} : \text{?} ] - Δ \text{?} \vert}^{2} + {\vert \text{?} Δ \text{?} - Δ \text{?} \vert}^{2} ) scale 2 + {λ}^{( 3 )} ( \text{?} {\vert Δ \text{?} ( x ) + \text{?} : [ Δ \text{?} - \text{?} : Δ \text{?} ] - Δ \text{?} \vert}^{2} + {\vert \text{?} Δ \text{?} - Δ \text{?} \vert}^{2} ) scale 3 \qquad ( 1 - 26 )$$

$$\text{?} \text{indicates text missing or illegible when filed}$$

where u^{h} is the macroscale displacement, ε^{I,(2)} is the cluster-wise strain tensor in the mesoscale (scale 2), ε^{I,(3)} is the cluster-wise strain tensor in the microscale (scale 3), λ⁽²⁾ and λ⁽³⁾ are Lagrangian multipliers applied on the loss functions contributed by the meso- and micro-scales, L⁽¹⁾ is the macroscale loss function (scale 1), L⁽²⁾ is the mesoscale loss function (scale 2), L⁽³⁾ is the microscale loss function (scale 3).

### 5. Summary

The present invention presents a novel framework, HiDeNN, as a narrow AI methodology to solve a variety of computational science and engineering problems. HiDeNN can assimilate many data-driven tools in an appropriate way, which provides a general approach to solve challenging computational problems from different fields. A detailed discussion on the construction of HiDeNN highlights the flexibility and generality of this framework. We illustrate an application of HiDENN to perform multiscale analysis of composite materials with heterogeneous microstructure. Unique features of HiDENN can offer automatic enrichment at the locations of strain concentration thus capturing effect of variable microstructure at part-scale. The results imply HiDENN's ability to be applied to a class of computational mechanics problem where each material point at macroscale corresponds to non-uniform structure at microscale such as functional gradient alloy materials. We need further research to make HiDeNN automatic for arbitrary 3D problems. Furthermore, we apply HiDENN to discover governing dimensionless parameters from experimental mechanistic data. The successful application of HiDeNN to such problems implies that similar framework can be applied to the field where the explicit physics is scarce, such as additive manufacturing. Finally, we propose future outlooks for solving three challenging problems using the same proposed AI framework. We demonstrate that HiDeNN has extra-ordinary features and can be a general solution method that takes advantage of ever increasing data from different experiments and theoretical model for fast prediction. A word of caution is that HiDENN is still a proposed framework and further extensions and validations are needed before it can become a generally applicable AI framework to solve problems in diverse fields from mechanical engineering to biological science in the near future.

### Example 2—Hierarchical Deep-Learning Neural Networks: Finite Elements and Beyond

The hierarchical deep-learning neural network (HiDeNN) is systematically developed through the construction of structured deep neural networks (DNNs) in a hierarchical manner, and a special case of HiDENN for representing Finite Element Method (or HiDeNN-FEM in short) is established. In HiDcNN-FEM, weights and biases are functions of the nodal positions, hence the training process in HiDeNN-FEM includes the optimization of the nodal coordinates. This is the spirit of r-adaptivity, and it increases both the local and global accuracy of the interpolants. By fixing the number of hidden layers and increasing the number of neurons by training the DNNs, rh-adaptivity can be achieved, which leads to further improvement of the accuracy for the solutions. The generalization of rational functions is achieved by the development of three fundamental building blocks of constructing decp hierarchical neural networks. The three building blocks are linear functions, multiplication, and inversion. With these building blocks, the class of deep learning interpolation functions are demonstrated for interpolation theories such as Lagrange polynomials, NURBS, isogeometric, reproducing kernel particle method, and others. In HiDeNN-FEM, enrichment functions through the multiplication of neurons is equivalent to the enrichment in standard finite element methods, that is, generalized, extended, and partition of unity finite element methods. Numerical examples performed by HiDeNN-FEM exhibit reduced approximation error compared with the standard FEM. Finally, an outlook for the generalized HiDeNN to high-order continuity for multiple dimensions and topology optimizations are illustrated through the hierarchy of the proposed DNNs.

The aforementeiond embodiment is detailed in Zhang, Lei, Lin Cheng, Hongyang Li, Jiaying Gao, Cheng Yu, Reno Domel, Yang Yang, Shaoqiang Tang, and Wing Kam Liu. “Hierarchical deep-learning neural networks: finite elements and beyond.” Computational Mechanics 67, no. 1 (2021): 207-230, which is hereby incorporated by reference in its entirety.

### Example 3—HiDe NN-PGD: Reduced Order Hierarchical Deep Learning Neural Networks

In one embodiment, the present invention is directed to a tensor decomposition (TD) based reduced-order model of the hierarchical deep-learning neural networks (HiDeNN). The HiDeNN-TD method keeps advantages of both HiDeNN and TD methods. The automatic mesh adaptivity makes the HiDeNN-TD more accurate than the finite element method (FEM) and conventional proper generalized decomposition (PGD) and TD, using a fraction of the FEM degrees of freedom. This work focuses on the theoretical foundation of the method. Hence, the accuracy and convergence of the method have been studied theoretically and numerically, with a comparison to different methods, including FEM, PGD, TD, HiDENN and Deep Neural Networks. In addition, the present invention has theoretically shown that the PGD/TD converges to FEM at increasing modes, and the PGD/TD solution error is a summation of the mesh discretization error and the mode reduction error. The proposed HiDENN-TD shows a high accuracy with orders of magnitude fewer degrees of freedom than FEM, and hence a high potential to achieve fast computations with a high level of accuracy for large-size engineering and scientific problems. As a trade-off between accuracy and efficiency, we propose a highly efficient solution strategy called HiDeNN-PGD. Although the solution is less accurate than HiDENN-TD, HiDENN-PGD still provides a higher accuracy than PGD/TD and FEM with only a small amount of additional cost to PGD.

The aforementioned processes are detailed in Zhang, Lei, Ye Lu, Shaoqiang Tang, and Wing Kam Liu. “HiDeNN-TD: Reduced-order hierarchical deep learning neural networks.” Computer Methods in Applied Mechanics and Engineering 389 (2022): 114414, which is hereby incorporated by reference in its entirety.

A reduced order hierarchical deep learning network has been proposed. The so-called HiDeNN-PGD is a combination of HiDENN and PGD with separated spatial variables. This combined method present several advantages over HiDENN and PGD methods. First, it allows to leverage the automatic mesh adaptivity of the HiDeNN method for reducing the mode number in PGD approximation. Second, combing PGD with HiDeNN reduces significantly the number of degrees of freedom for HiDENN and potentially leads to a high computational efficiency. Furthermore, we have demonstrated that both HiDeNN and HiDeNN-PGD can provide more accurate solutions than FEM and PGD (or MS), through an error analysis with the help of analyzing the approximation function spaces.

The numerical results have confirmed the mathematical analysis. These examples have been performed based on 2D and 3D Poisson problems. It is shown that the proposed HiDeNN-PGD method can provide accurate solutions with the least degrees of freedom. In order to have an idea for the prescribed number of modes in HiDeNN-PGD, we have studied numerically the convergence rate on PGD approximation. It has been found that the convergence rate on the mode number is insensitive to the mesh size. Therefore, we can expect to use a coarse mesh PGD to compute a roughly estimated mode number for HiDeNN-PGD. This finding is interesting and provides a useful guideline on the choice of the number of modes for HiDeNN-PGD or other PGD-based methods that may require a better optimality in terms of basis.

### Example 4—Adaptive Hyper Reduction for Additive Manufacturing Thermal Fluid Analysis

In one embodiment, the present invention is directed to adaptive hyper reduction for additive manufacturing thermal fluid analysis. In particular, thermal fluid coupled analysis is essential to enable an accurate temperature prediction in additive manufacturing. However, numerical simulations of this type are time-consuming, due to the high non-linearity, the underlying large mesh size and the small time step constraints. The present invention discloses a novel adaptive hyper reduction method for speeding up these simulations. The difficulties associated with non-linear terms for model reduction are tackled by designing an adaptive reduced integration domain. The proposed online basis adaptation strategy is based on a combination of a basis mapping, enrichment by local residuals and a gappy basis reconstruction technique. The efficiency of the proposed method is demonstrated by representative 3D examples of additive manufacturing models, including single-track and multi-track cases.

The aforementioned embodiment is detailed in Lu, Ye, Kevontrez Kyvon Jones, Zhengtao Gan, and Wing Kam Liu. “Adaptive hyper reduction for additive manufacturing thermal fluid analysis.” Computer Methods in Applied Mechanics and Engineering 372 (2020): 113312, which is hereby incorporated by reference in its entirety.

### Example 5—Microscale Structure to Property Prediction for Additively Manufactured IN625 through Advanced Material Model Parameter Identification

In one embodiment, the present invention is used to predict the grain-average clastic strain tensors of a few specific challenge grains during tensile loading, based on experimental data and extensive characterization of an IN625 test specimen. First, a characterized microstructural image from the experiment was directly used to predict the mechanical responses of certain challenge grains with a genetic algorithm-based material model identification method. Later, a proper generalized decomposition (PGD)-based reduced order method is introduced for improved material model calibration. This data-driven reduced order method is efficient and can be used to identify complex material model parameters in the broad field of mechanics and materials science. The results in terms of absolute error have been reported for the original prediction and re-calibrated material model. The predictions show that the overall method is capable of handling large-scale computational problems for local response identification. The re-calibrated results and speed-up show promise for using PGD for material model calibration.

The aforementioned embodiment is detailed in Saha, Sourav, Orion L. Kafka, Ye Lu, Cheng Yu, and Wing Kam Liu. “Microscale structure to property prediction for additively manufactured IN625 through advanced material model parameter identification.” Integrating Materials and Manufacturing Innovation 10, no. 2 (2021): 142-156, which is hereby incorporated by reference in its entirety.

### Example 6—Macroscale Property Prediction for Additively Manufactured IN625 from Microstructure Through Advanced Homogenization

In one embodiment, the present invention is directed to predict the mechanical response of tensile coupons of IN625 as function of microstructure and manufacturing conditions. A representative volume clement (RVE) approach was coupled with a crystal plasticity material model, solved within the fast Fourier transformation (FFT) framework for mechanics, to address the challenge. During the competition, material model calibration proved to be a challenge, prompting the introduction in this manuscript of an advanced material model identification method using proper generalized decomposition (PGD). Finally, a mechanistic reduced order method called self-consistent clustering analysis (SCA) is shown as a possible alternative to the FFT method for solving these problems. Apart from presenting the response analysis, some physical interpretation and assumptions associated with the modeling are discussed.

The aforementioned embodiment is detailed in Saha, Sourav, Orion L. Kafka, Ye Lu, Cheng Yu, and Wing Kam Liu. “Macroscale Property Prediction for Additively Manufactured IN625 from Microstructure Through Advanced Homogenization.” Integrating Materials and Manufacturing Innovation 10, no. 3 (2021): 360-372, which is hereby incorporated by reference in its entirety.

### Example 7—Composites Science and Technology Knowledge Database Creation for Design of Polymer Matrix Composite

In one embodiment, the present invention discloses a mechanistic data science (MDS) framework to build a composite knowledge database and use it for composite materials design. MDS framework systematically uses the data science techniques to extract the mechanistic knowledge from a composite materials system. In particular, first, a composite response database is generated for three matrices and four fibers combination using a physics-based mechanistic reduced order model. Then the composites stress-strain responses are analyzed, and mechanistic features of the composites are identified. Further, the materials are represented in a latent space using dimension reduction techniques. A relationship of the composite properties and the constituents' material features are established through a learning process. The present invention demonstrates the capability of knowledge database created through the MDS steps in predicting materials systems for a set of target composite properties, including transverse modulus of elasticity, yield strength, resilience, modulus of toughness, and density for unidirectional fiber composites. The MDS model is predictive with reasonable accuracy, and capable of identifying the materials system along with the tuning required to achieve desired composite properties. This MDS framework can be exploited for other materials system design, creating new opportunity for performance guided materials design.

The aforementioned embodiment is detailed in Hannah Huang, Satyajit Mojumder, Derick Suarez, Abdullah Al Amin, Mark Fleming, and Wing Kam Liu. “Composites Science and Technology Knowledge database creation for design of polymer matrix composite.” with detailed data available at https://github.com/hannahhuang00/MDS_Composite, which is hereby incorporated by reference in its entirety.

### Example 8—Multiresolution Clustering Analysis for Efficient Modeling of Hierarchical Material Systems

In one embodiment of the present invention, a mechanistic machine learning framework is developed for fast multiscale analysis of material response and structure performance. The new capabilities stem from three major factors: (1) the use of an unsupervised learning (clustering)-based discretization to achieve significant order reduction at both macroscale and microscale; (2) the generation of a database of interaction tensors among discretized material regions; (3) concurrent multiscale response prediction to solve the mechanistic equations. These factors allow for an orders-of-magnitude decrease in the computational expense compared to FEⁿ, n [symbol] 2. This method provides sufficiently high fidelity and speed to reasonably conduct inverse modeling for the challenging tasks mentioned above.

In particular, a multiresolution clustering analysis method is proposed for properties and performance prediction by concurrently modeling material behaviors at multiple length scales. The key idea of this method is to solve a set of fully coupled governing partial differential equations using the clusters generated from unsupervised machine learning at multiple length scales and a precomputed database of interaction tensors among these clusters. This method features an unprecedented balance of accuracy and efficiency by combining the advantages of both physics-based modeling and data-science based order reduction. Potential application to materials design is demonstrated with a particle reinforced composite, roughly analogous to a precipitate strengthened alloy, under uniaxial tensile loading. The example results show that the composite stiffness and yield strength could be improved by adding primary and secondary particles, and changing particle shapes. Refined material models can be used within this efficient multiscale modeling framework to discover more structure-property relationships, guiding hierarchical material design.

Theoretically, MCA works for material systems that involve an arbitrary number of discrete scales as long as continuum and scale separation assumptions can be made. However, attention must be paid to microstructural modeling and design at the nanoscale. For example, there are strong interactions between nanoparticles and dislocations resulting in a size effect in precipitation strengthened alloy systems. One way to capture the size effect would be to introduce a strain-gradient formulation of the Lippmann-Schwinger equation. Furthermore, problems with moving boundaries (e.g. moving contact between the roller and the part in therolling process) and microscale problems with significantly evolving microstructures (e.g. micro cracks) require special considerations. For example, one could adopt the arbitrary Lagrangian Eulerian method in a moving contact problem where the clusters are fixed while materials points are allowed to flow in and out of a cluster. To accurately capture evolving microstructures, adaptive clustering methods might be used in a similar sense to the adaptive finite element methods along with a fast method to update the interaction tensors.

The afotementioned method is detailed in Yu, Cheng, Orion L. Kafka, and Wing Kam Liu. “Multiresolution clustering analysis for efficient modeling of hierarchical material systems.” Computational Mechanics 67, no. 5 (2021): 1293-1306, which is hereby incorporated by reference in its entirety.

### Example 9—Concurrent N-Scale Modeling for non-Orthogonal Woven Composite

Concurrent analysis of composite materials can provide the interaction among scales for better composite design, analysis, and performance prediction. In one embodiment of the present invention, a data-driven concurrent n-scale modeling theory (FExSCAⁿ⁻¹) is proposed utilizing a mechanistic reduced order model (ROM) called self-consistent clustering analysis (SCA). The present invention demonstrated this theory with a FExSCA² approach to study the 3-scale woven carbon fiber reinforced polymer (CFRP) laminate structure. FExSCA² significantly reduced expensive 3D nested composite representative volume clements (RVEs) computation for woven and unidirectional (UD) composite structures by developing a material database. The modeling procedure is established by integrating the material database into a woven CFRP structural numerical model, formulating a concurrent 3-scale modeling framework. This framework provides an accurate prediction for the structural performance (e.g., nonlinear structural behavior under tensile load), as well as the woven and UD physics field evolution. The concurrent modeling results are validated against physical tests that link structural performance to the basic material microstructures. The proposed methodology provides a comprehensive predictive modeling procedure applicable to general composite materials aiming to reduce laborious experiments needed.

The aforementioned embodiment is detailed in Gao, Jiaying, Satyajit Mojumder, Weizhao Zhang, Hengyang Li, Derick Suarez, Chunwang He, Jian Cao, and Wing Kam Liu. “Concurrent n-scale modeling for non-orthogonal woven composite.” arXiv preprint arXiv:2105.10411 (2021), which is hereby incorporated by reference in its entirety.

### Example 10—Data-Driven Discovery of Dimensionless Numbers and Scaling Laws from Experimental Measurements

Dimensionless numbers and scaling laws provide elegant insights into the characteristic properties of physical systems. Classical dimensional analysis and similitude theory fail to identify a set of unique dimensionless numbers for a highly-multivariable system with incomplete governing equations. In one embodiment of the present invention, the principle of dimensional invariance is embedded into a two-level machine learning scheme to automatically discover dominant and unique dimensionless numbers and scaling laws from data. The disclosed methodology, called dimensionless learning, can reduce high-dimensional parametric spaces into descriptions involving just a few physically-interpretable dimensionless parameters, which significantly simplifies the process design and optimization of the system. The algorithm is demonstrated by solving several challenging engineering problems with noisy experimental measurements (not synthetic data) collected from the literature. The examples include turbulent Rayleigh-Benard convection, vapor depression dynamics in laser melting of metals, and porosity formation in 3D printing. The present invention also shows that the proposed approach can identify dimensionally-homogeneous differential equations with minimal parameters by leveraging sparsity-promoting techniques.

The aforementioned embodiment is detailed in Xie, Xiaoyu, Wing Kam Liu, and Zhengtao Gan. “Data-driven discovery of dimensionless numbers and scaling laws from experimental measurements.” arXiv preprint arXiv:2111.03583 (2021), which is hereby incorporated by reference in its entirety.

### Example 11—Sound Data

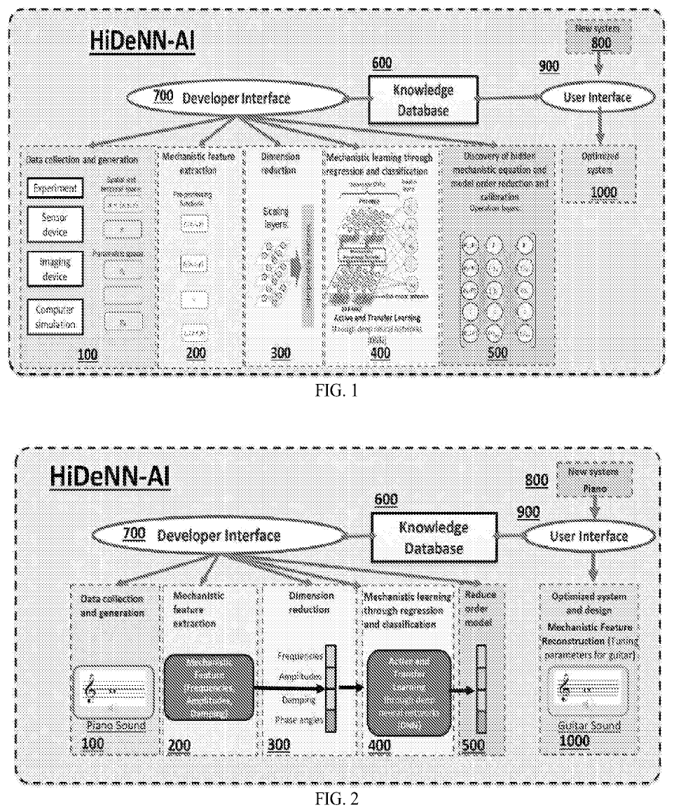

FIG. 2 demonstrates conversion from piano sound to guitar sound. N is much less than the number of parameters compared to CNN or wavelets.

As shown in FIG. 2, for signal analysis, module (100) is used for the data collection and generation from original sound file. The sound data are collected from the original sound records by reading the time series data. After extracting the data, module (200) and module (300) are used to extract the mechanistic features from the original data and compress the original data into four features. The vibration of the sound wave is approximated as a spring-mass-damper system with four sets of features: frequencies, amplitudes, damping coefficients, and phase angles. Short-time Fourier transform and Fourier transform are used to extract the frequency, amplitude, damping coefficients. The phase angles are extracted by nonlinear least-squares regression. Module (400) converts extracted piano features to guitar features by active and transfer learning through a Deep Neural Network. The converted guitar features can be regarded as a reduce order model for guitar sound, which is shown in module (500). The knowledge database in module (600) is generated by training the procedure (100) to (500) with multiple pairs of guitar sound and piano sound. After finishing the development of the knowledge database by the developer interface (700), the HiDeNN-AI can transfer a new piano sound from (800) to a corresponding guitar sound in (1000) with module (900) as the user interphase. The method can extract mechanistic features from signals as process signature. The feature extraction method can be optimized to obtain multiscale and multiresolution information from data. The wavelet/spectral operator can be combined with convolutional neural network to develop a reduced order model for any engineering or physical process.

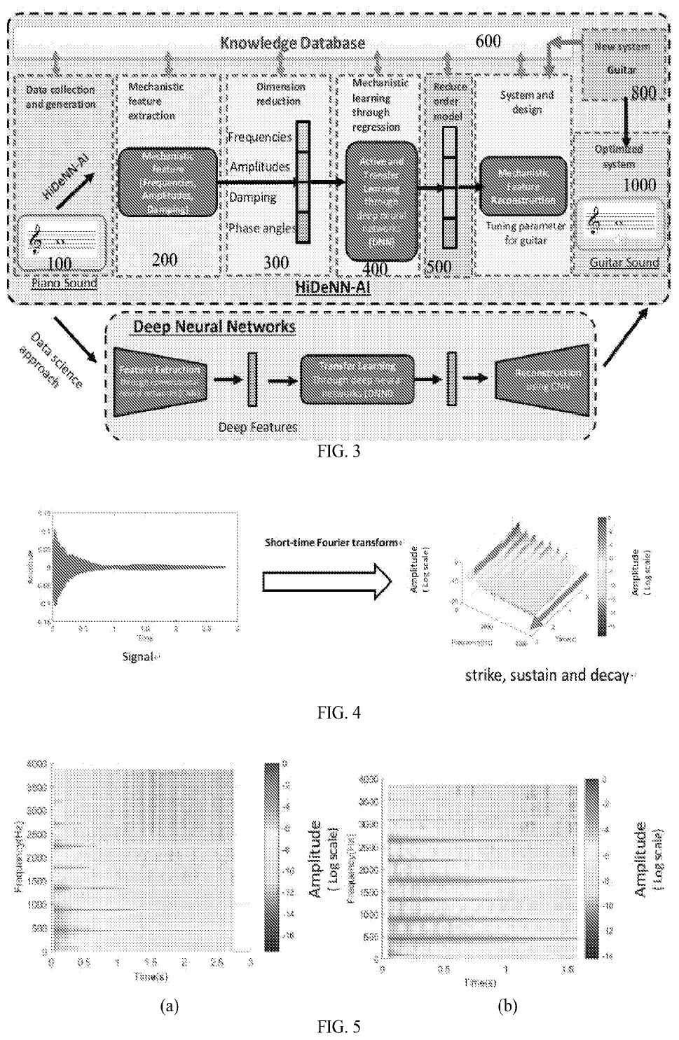

FIG. 3 provides another embodiment illustrating using Hierarchical Deep learning Neural Networks (HiDeNN) to learn from a system (Piano sound) and transfer the knowledge for a new system (Guitar sound).

FIG. 4 shows a process for mechanistic feature extraction. In particular, to enhance the reconstruction of the authentic A4 key, Short Time Fourier Transform (STFT) is used to reveal the strike, sustain and decay. The Short-time Fourier transform (STFT), is a Fourier-related transform used to determine the sinusoidal frequency and phase content of local sections of a signal as it changes over time.

FIG. 5 shows extracted features of A4 piano sound and guitar. All eight sets of features from authentic A4 piano and authentic A4 guitar sound. In particular, panel (a) of FIG. 5 shows STFT of the authentic A4 piano sound, and panel (b) of FIG. 5 shows STFT of the authentic A4 guitar sound. Optimal coefficients to reconstruct the authentic A4 piano sound are reflected in Table 11-1. Optimal coefficients to reconstruct the authentic A4 guitar sound are reflected in Table 11-2.

TABLE 11-1
Optimal coefficients to reconstruct the
authentic A4 piano sound are reflected

| | Frequencies | Initial | Damping | Phase angles |
|---|---|---|---|---|
| Type | (Hz) | amplitudes | coefficients | (rad) |
| Fundamental | 4.410E+02 | 1.034E−01 | 3.309E+00 | 6.954E−01 |
| Harmonics | 8.820E+02 | 1.119E−02 | 1.844E+00 | 7.202E−01 |
| | 1.323E+03 | 6.285E−03 | 5.052E+00 | 3.469E−01 |
| | 1.764E+03 | 7.715E−04 | 2.484E+00 | 5.170E−01 |
| | 2.205E+03 | 1.455E−03 | 8.602E+00 | 5.567E−01 |
| | 2.646E+03 | 5.130E−04 | 1.198E+01 | 1.565E−01 |
| | 3.087E+03 | 1.899E−04 | 8.108E+00 | 5.621E−01 |
| | 3.528E+03 | 3.891E−05 | 3.282E+00 | 6.948E−01 |

TABLE 11-2
Optimal coefficients to reconstruct the authentic A4 guitar sound

| | Frequencies | Initial | Damping | Phase angles |
|---|---|---|---|---|
| Type | (Hz) | amplitudes | coefficients | (rad) |
| Fundamental | 4.400E+02 | 2.346E−02 | 1.287E+00 | 4.218E−01 |
| Harmonics | 8.800E+02 | 1.142E−02 | 1.865E+00 | 9.157E−01 |
| | 1.320E+03 | 3.630E−03 | 2.176E+00 | 7.922E−01 |
| | 1.760E+03 | 7.761E−03 | 1.100E+00 | 9.595E−01 |
| | 2.200E+03 | 7.860E−03 | 3.346E+00 | 6.557E−01 |
| | 2.640E+03 | 9.594E−03 | 2.504E+00 | 3.571E−02 |
| | 3.080E+03 | 1.088E−03 | 1.666E+00 | 8.491E−01 |
| | 3.520E+03 | 1.387E−03 | 2.610E+00 | 9.340E−01 |

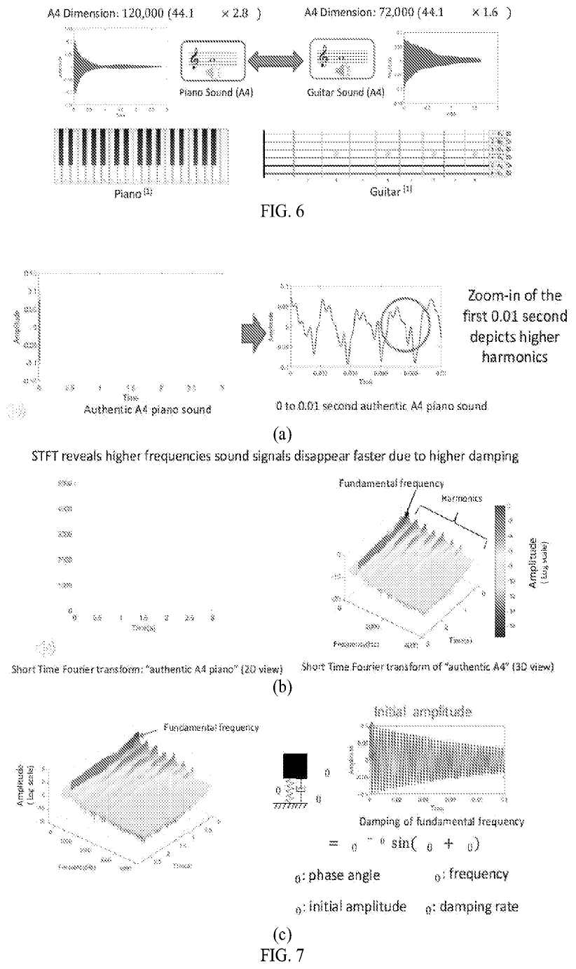

FIG. 6 shows a process of data collection and generation for sound data. In particular, the process starts with training of the pair of A4 piano and A4 guitar sound files: Sample rate: 44.1 kHz; Duration: 2.8 second for the piano and 1.6 seconds for the guitar. Thereafter, repeat for A5, B5, C5, C6, D5, E5, G5 piano and guitar sound files with duration ranging from 1.5 to 3.0 seconds. These 8 pairs of keys constitute the training sets. To reduce the data dimensions, the extracted four features using STFT and least square optimization for each data set is used for regression between the piano keys and the guitar keys (8×4×8 input, 8×4×8 output).

FIG. 7 shows a process of dimension reduction for sound data regarding frequencies, amplitudes and damping coefficients. As shown in panel (a)-(b) FIG. 7, Zoom-in of the first 0.01 second depicts higher harmonics. STFT reveals higher frequencies sound signals disappear faster due to higher damping. Panel (b) of FIG. 7 shows a 2D (left) and 3D (right) of Short Time Fourier transform of “authentic A4 piano”. Panel (c) of FIG. 7 shows dimension reduction regarding damping coefficients as follow:

y=α₀e^{-b}₀^{t} sin(ω₀t+Φ₀)

Φ₀: phase angle ω₀: frequency α₀: initial amplitude b₀: damping rate

By using exponential fitting of time history, the values of each damping constant can be determined. The fitting can also be determined during the optimization stage using least square optimization.

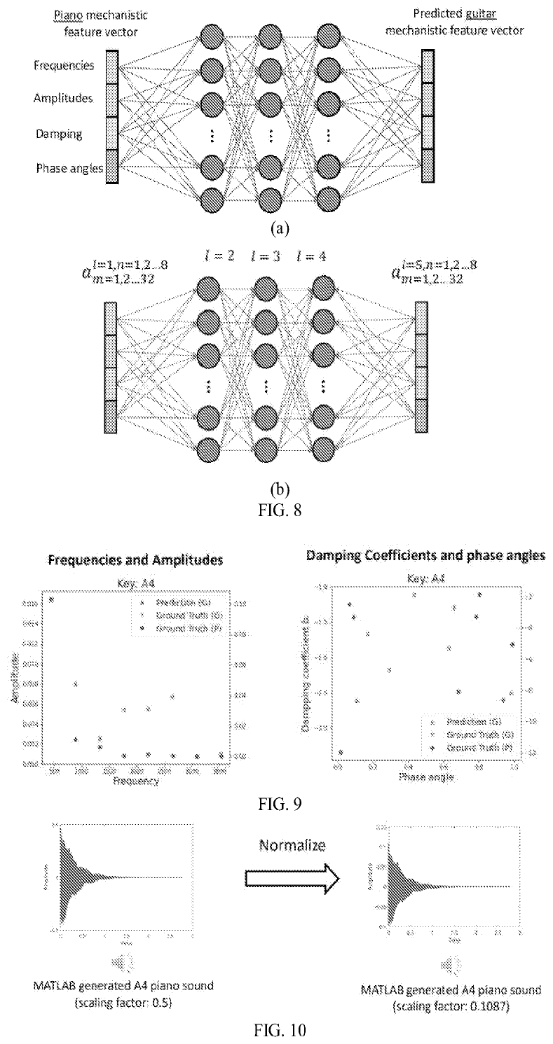

Panel (a) of FIG. 8 shows a process of mechanistic learning through regression. In one embodiment, extracted Mechanistic features includes 8 frequencies, 8 amplitudes, 8 damping coefficient, and 8 Phase angles, while the neural networks includes 3 hidden layers with 100 neurons. Through the regression, generation of guitar sound is possible with a significantly smaller dimensions. Panel (b) of FIG. 8 shows a process of optimization of the feed forward neural network training.

Input/output data dimension: M×N

M=4 features×8 sets=32

N=8 (pairs)

M represents each sound file can be reduced to 8 sets of sine waves with 4 individual features of each set. N represents 8 pairs of guitar and piano sound files are used in training. In panel (b) of FIG. 8, 1 is index of layers and n is index of samples. find wᵢⱼ^{l=2}, bᵢⱼ^{l=2}, wᵢⱼ^{l=3}, bᵢⱼ^{l=3}, wᵢⱼ^{l=4}, bᵢⱼ^{l=4}, wᵢⱼ^{l=5}, bᵢⱼ^{l=5},

$$minimine loss = \frac{1}{N \times M} {\sum }_{n = 1}^{N} {\sum }_{m = 1}^{M} {‖ \text{?} - \text{?} ‖}^{2}$$

$$\text{?} \text{indicates text missing or illegible when filed}$$

where: α_{m=1,2 . . . M}^{l=1,n}: features from piano sound
α_{m=1,2 . . . M}^{*l=5,n}: ground truth features of guitar sound
α_{m=1,2 . . . M}^{l=5,n}: predicted features of guitar sound
N_{N}(l): number of neurons in layer l
N: number of samples

M: number of all features in a sample

$$\text{?} = \text{?} ( \text{?} ( \text{?} ( \text{?} + \text{?} ) + \text{?} ) + \text{?} ) + \text{?}$$

$$\text{?} \text{indicates text missing or illegible when filed}$$

FIG. 9 shows system and design of sound reconstruction. In one embodiment, steps for generate the guitar sounds for each key from the input piano key includes: step (1) transform a piano sound to mechanistic features α_{m=1,2 . . . M}^{k=1}; step (2) Feed input piano data (8 (for each frequency) sets of 4 features) into the trained Feed-Forward Neural Network [symbol] _{FFNN}; step (3) Get the corresponding guitar features of the similar set α_{m=1,2 . . . M}^{k=5}= [symbol] _{FFNN}(α_{m=1,2 . . . M}^{k=1}); step (4) Generate guitar sound by generated features f_{guitar}(t)=Σαᵢe^{-b}^{ᵢ}^{l} sin(2πωᵢt+φᵢ), where ωᵢ is the ith frequency, αᵢ is the ith initial amplitude, bᵢ is the ith damping coefficient, and φᵢ is the ith phase angle. FIG. 9 shows the reconstruct a single key, and based on reconstructed keys, a guitar melody is created, using piano note of “Shifted Octave Twinkle Twinkle little star with C5, C5, G5, G5, A5, A5, G5”.

FIG. 10 shows a process of audio normalization. In one embodiment, all sound files are normalized to the same volume using peak normalization. Peak normalization is to adjust the recording based on the highest signal level present in the recording.

$${y}^{normalized} = \frac{{y}^{original}}{maximum ( \vert {y}^{original} \vert )} \times η$$

$$η : scaling factor$$

In recording of FIG. 10, η=0.1087. The value 0.1087 is set based on the maximum peak in the authentic A4 piano sound.

FIG. 11 shows a comparison between authentic vs generated sound. It should be noted that MATLAB generated sound is created by MATLAB program with the coefficients found by the optimization loop. Spring-mass-dashpot system can approximate piano sound. Other factors should be considered such as the alignment of the vibration center point, response spectrum, variance in equal tempered tuning. A wisely chose optimization algorithms can give optimal coefficients with a better accuracy.

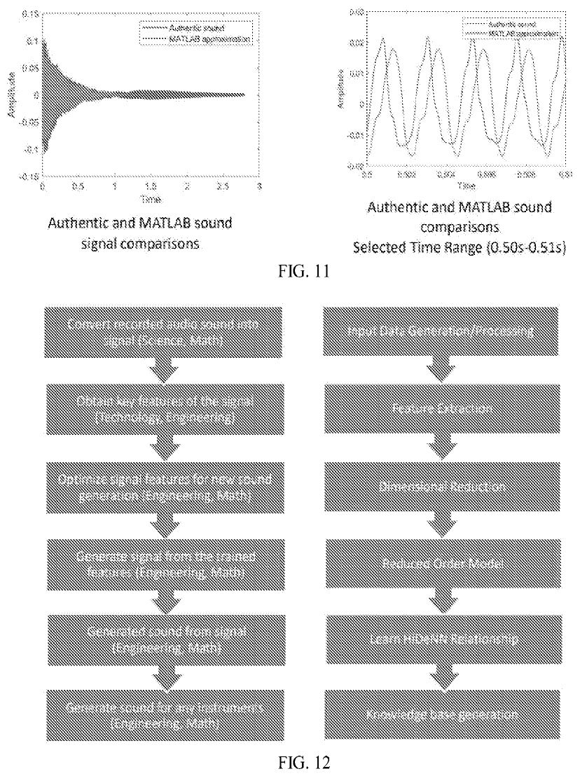

FIG. 12 shows a diagram of HiDENN-AI Instrument Sound Reconstruction. The left panel is using of HiDeNN-AI specifically for sound reconstruction, while the right panel shows a steps of a general process of HiDcNN-AI.

### Example 12—Discover Explicit Form of Governing Dimensionless Numbers

In one embodiment of the invention, HiDeNN-AI software modules can be used to discover explicit form of governing dimensionless numbers from pure data.

In the module (100), the space, parameters are used as input variables to discover dimensionless numbers and predict desired outputs. The high dimensional inputs are then transformed to a set of dimensionless numbers by the scaling network in the module (300). In the module (400) nonlinear relationships between the dimensionless numbers and target output are learned by the deep neural networks. The method can predict complex behaviors of the problems in an accurate and efficient manner by leveraging the discovered dimensionless numbers. The method also reduces the physical dependency of dimensional input parameters. The method improves the explain ability of deep learning network and can be applied to many physical, chemical, and biological systems.

### Example 13—Constructing a Reduced Order Deep Learning Model

In one embodiment of the invention, HiDeNN-AI software modules can be utilized for constructing a reduced order deep learning model for solving partial differential equations. In this case, the module (100) uses space, time, and parameters as input for constructing finite element shape functions. The shape functions will be then decomposed to separated one dimensional functions using PGD (Proper Generalized Decomposition). This decomposition can reduce largely the degrees of freedom (DoF) involved in the problem and can consequently a reduced computational cost. An example of this is that the resulting HiDeNN-PGD method can reduce DoF from 10,000 to 100 with comparison to HiDeNN. In the module (500), the separated functions are used as input for the operations layers to solve the physics based partial differential equations. This solution leverages the automatic mesh adaptivity of the HiDENN method and can keep the smallest number of modes for a given accuracy. The example of a Poisson problem showed that only three modes are necessary for a significantly higher accuracy than FEM and conventional PGD methods that require even more modes. This method provides a new way to solve physics-based problems at a high speed and accuracy.

### Example 14—Design Lightweight Composite Structures

In one embodiment of the invention, HiDeNN-AI framework can be used to design lightweight composite structures by optimizing the materials microstructure in multiple length scales by tuning nanofillers, unidirectional fiber volume fractions and woven patterns.

Previous patented work on self-consistent clustering analysis (SCA), displays the use of reduced order models in significantly decreasing computation time for multiscale mechanical analyses. This work has been expanded to 2+ scales, in the so called multi-resolution self-consistent clustering analysis (MCA), which has already been filed for patented internationally and has been shown to be able to efficiently and accurately model various classes of multiscale material systems, including reinforced composites. Here it is proposed a new variant of the SCA methodology, FE-SCA-SCA (or FE-SCA\hat{ }n). Where finite element (FE) software can be integrated into the SCA methodology—wherein FE software can interface at the macro (or top level) of the simulation, with n sub-levels of a multiscale simulation being handled through SCA, for composite design. FE-SCA\hat{ }n is integrated into the HiDeNN-AI platform. Module (100) can be used by defining composite constituents, microstructure, volume fraction and temperature as inputs to FE-SCA\hat{ }n for generation of stress-strain data. Module (200) is used wherein mechanistic features such as strain concentration, von-Mises stress distribution, etc., can be extracted and further dimension can be reduced by applying a K-means clustering algorithm in module (300). A mechanistic reduce order model (500) can be established by utilizing the offline clustering database and solving Lipmann-Schwinger equations online. This reduce order model can predict the mechanical response in a very fast and efficient manner and can be extended to multiple scales. Once the reduce order model is set up, the parametric space can be explored using active learning algorithm and neural network-based regression module (400) can learn the hidden relationship for the parametric space. All these trainings are saved to the knowledge database module (600) through a developer interface (700). Once the knowledge database is set up a user can use it for design and optimization of a new composite materials system which includes modules (800-1000).

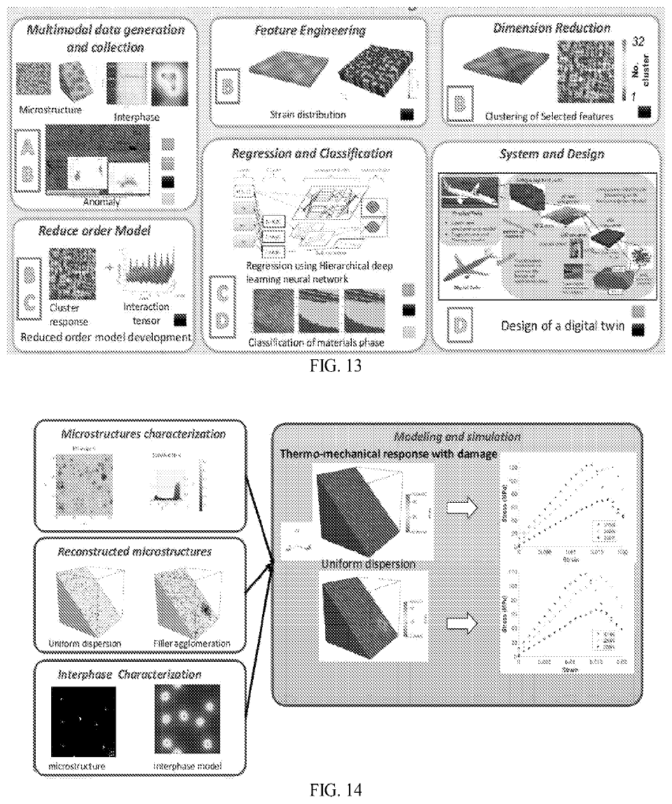

FIG. 13 shows mechanistic machine learning for decision making. In one embodiment, multimodal data generation and collection process by module (100) collects information of multimodal data from experiment and simulation, composite microstructure monitoring for anomaly, reconstruction of microstructure with interphase. The feature extraction and engineering process by module (200) extract features such as strain distribution, strain concentration, von Mises stress, etc. The dimension reduction process by module (300) provides clustering of selected features, such as K-means clustering for dimension reduction, reduce the problem size without loosing physical insights. The reduce order model provides physics based reduce order model (SCA, MCA), predict nonlinear materials response, and is very accurate and efficient (˜10000 times speed up). The regression and classification process by module (400) provides regression using hierarchical deep learning neural network, such as identifying the structure -property relation of composite materials system; classify the materials response based on physical insight (Interpretable ML). The system and design process may provide rapid design iteration, microstructure informed part design, virtual composite design (Digital Twin), and etc.

FIG. 14 shows a multimodal data fusion for modeling and simulation. Microstructures characterization, reconstructed microstructures, and interphase characterization are collected. Thermal residual stress distribution at 295 K are generated during modeling and simulation. Temperature dependent stress-strain curve is generated.

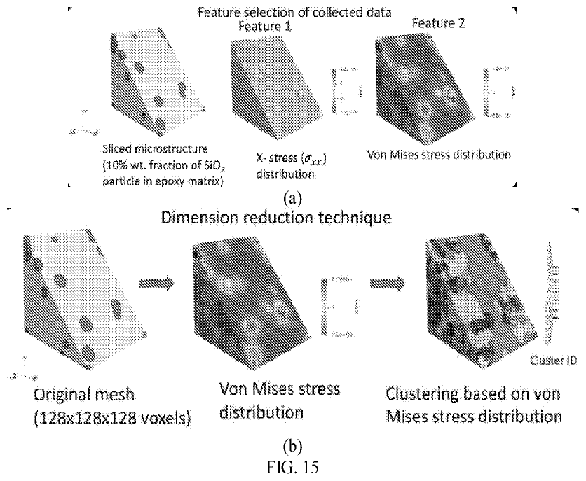

FIG. 15 shows a process of feature engineering and dimension reduction of high-fidelity model. As shown in panel (a) of FIG. 15, the process of feature engineering identifies features from the data collected from modeling, simulation and experiment. Example features may be von Mises Stress, strain concentration, etc. As shown in panel (b) of FIG. 15, the process of dimension reduction cluster the materials points based on similarity of features, e.g. K-means clustering, and reduces the problem dimension significantly. The accuracy depends on number of clusters.

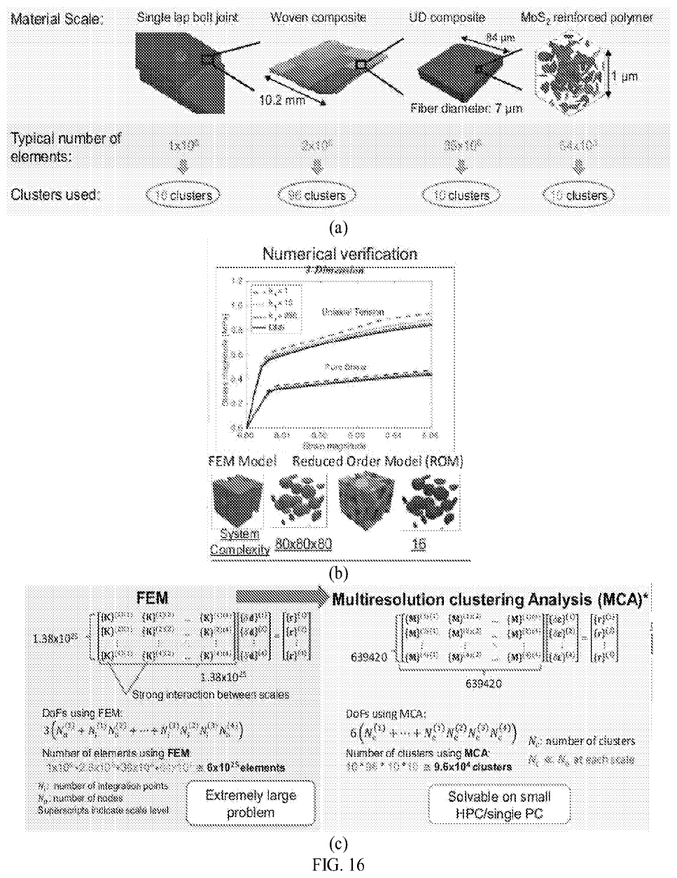

Panels (a)-(c) of FIG. 16 show a process of solving the tyranny of scales in complex material systems using Reduce Order Model. Panel (a) shows the process of dimension reduction during which the number of elements are clustered. During the process, extremely large problem is reduced to solvable on small HPC/single PC.

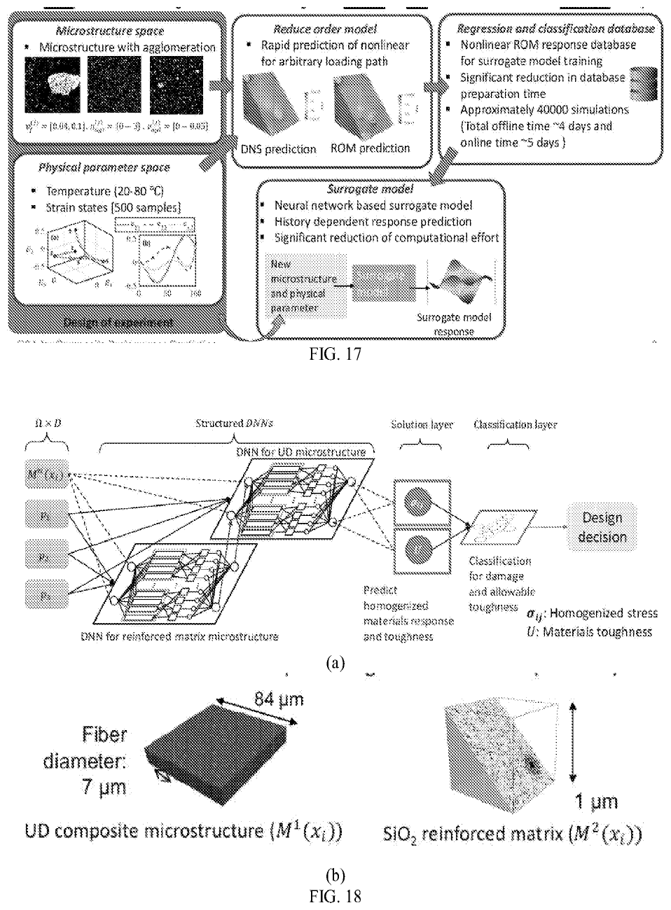

FIG. 17 shows a process of regression and classification for materials system knowledge. The goal of the process is fast prediction of homogenized stress and toughness history for any microstructure RVE for arbitrary load path. The microstructure space and Physical parameter space are collected and undergo a reduce order model for rapid prediction of nonlinear for arbitrary loading path, e.g. DNS prediction and ROM prediction. Regression and classification database may include nonlinear ROM response database for surrogate model training; and thus significant reducte database preparation time. Approximately 40000 simulations may be included.

FIG. 18 shows a process of regression and classification using Hierarchal Deep learning Neural Network using module (400).

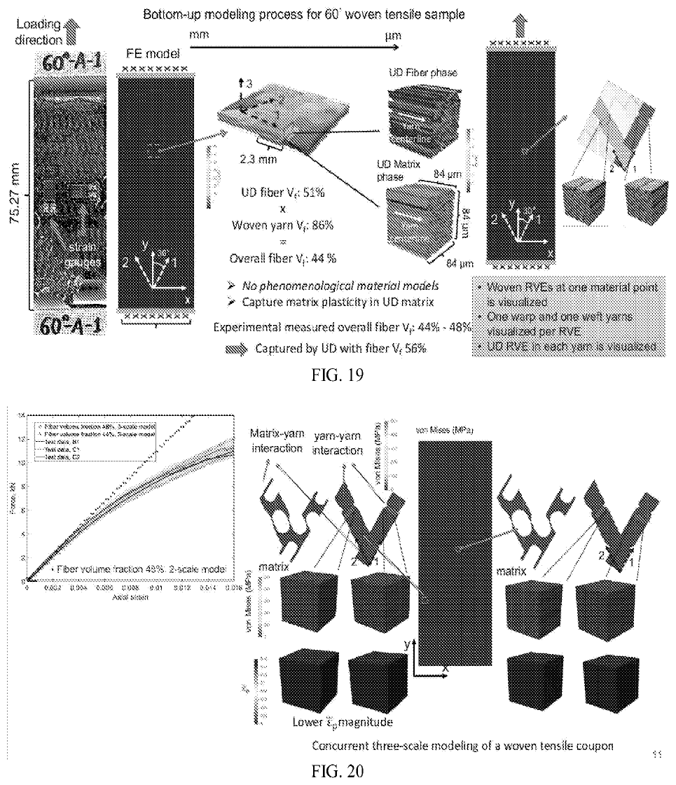

FIG. 19 shows a process of system and design of a non-orthogonal woven composite in multiscale. Particularly, FIG. 19 shows bottom-up modeling process for 60° woven tensile sample. UD fiber Vf: 51% x Woven yarn Vf: 86%=Overall fiber Vf: 44%. During the process, woven RVEs at one material point is visualized. One warp and one weft yarns are visualized per RVE. UD RVE in cach yarn is visualized.

FIG. 20 shows a process of system and design of a non-orthogonal woven composite in multiscale. During the process, ignoring yarn plasticity leads to inaccurate prediction; the 3-scale model predicts the loading force history with good accuracy; and two different Vf form the lower and upper bounds for the loading force history. Lower plastic strain concentrates in low stress regions. Matrix phase in the yarn carries considerable loads under shear deformation.

### Example 15—Mechanical Properties Prediction in Metal Addictive Manufacturing

Metal additive manufacturing provides remarkable flexibility in geometry and component design, but localized heating/coolingheterogeneity leads to spatial variations of as-built mechanical properties, significantly complicating the materials design process. In one embodiment, the current invention is directed to a mechanistic data-driven framework integrating wavelet transforms and convolutional neural networks to predict location-dependent mechanical properties over fabricated parts based on process-induced temperature sequences, i.e., thermal histories. The framework enables multiresolution analysis and importance analysis to reveal dominant mechanistic features underlying the additive manufacturing process, such as critical temperature ranges and fundamental thermal frequencies. The invention systematically compares the developed approach with other machine learning methods. The results demonstrate that the developed approach achieves reasonably good predictive capability using a small amount of noisy experimental data. It provides a concrete foundation for a revolutionary methodology that predicts spatial and temporal evolution of mechanical properties leveraging domain-specific knowledge and cutting-edge machine and deep learning technologies.

The aforementioned embodiment is detailed in Xie, Xiaoyu, Jennifer Bennett, Sourav Saha, Ye Lu, Jian Cao, Wing Kam Liu, and Zhengtao Gan. “Mechanistic data-driven prediction of as-built mechanical properties in metal additive manufacturing.” npj Computational Materials 7, no. 1 (2021): 1-12, which is hereby incorporated by reference in its entirety.

### Example 16—Proposed ICME-Mechanistic Machine Learning Approach

### 1. ICME-MIDS Method for AM Fatigue Prediction

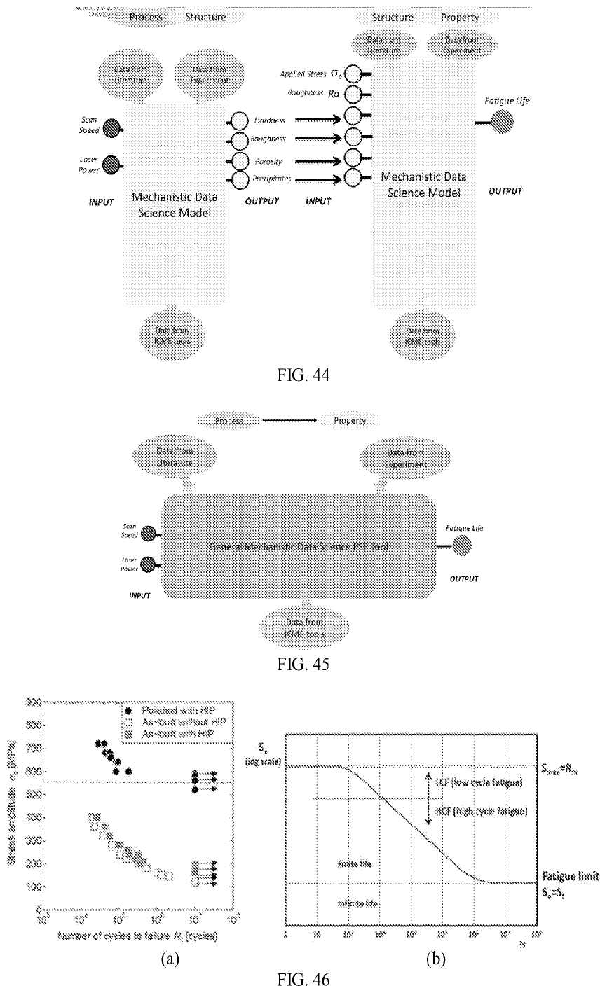

FIGS. 43-45 show flow diagrams reagrding ICME-MDS method for AM Fatigue prediction. Assimilation of data are from multiple experiments, and leveraging data are from multiple materials system. ICME tools may include (1) Part-scale Process Code: GAMMA, which is very fast; (2)

Thermal-CFD Code: AM-CFD, which is fast with high accuracy; (3) Powder-scale Multi-phase Code, which is high-fidelity; (4) Microstructure Prediction Code: CAFE; (5) Properties prediction Code: CPSCA; (6) Multiscale High Cycle Fatigue Code: Space Time CPSCA.

### 2. Different Stages and Physics of Fatigue Life

FIG. 46 refletcs different stages and physics of fatigue life. FIG. 46 (a) shows S-N Curve (Applied stress fatigue life relation); and FIG. 46 panel (b) shows an example S-N curve. In particular, low cycle fatigue may show high loading; fails <10⁴ cycles; and dominated by plastic deformation. High cycle fatigue may show low loading; fails >10⁶ cycles; and dominated by local strain concentration. Intermediate cycle fatigue may show material fails between 10⁴˜10⁶ cycles. It should be noted that for proper estimate of fatigue life both high and low cycle fatigue need to be considered.

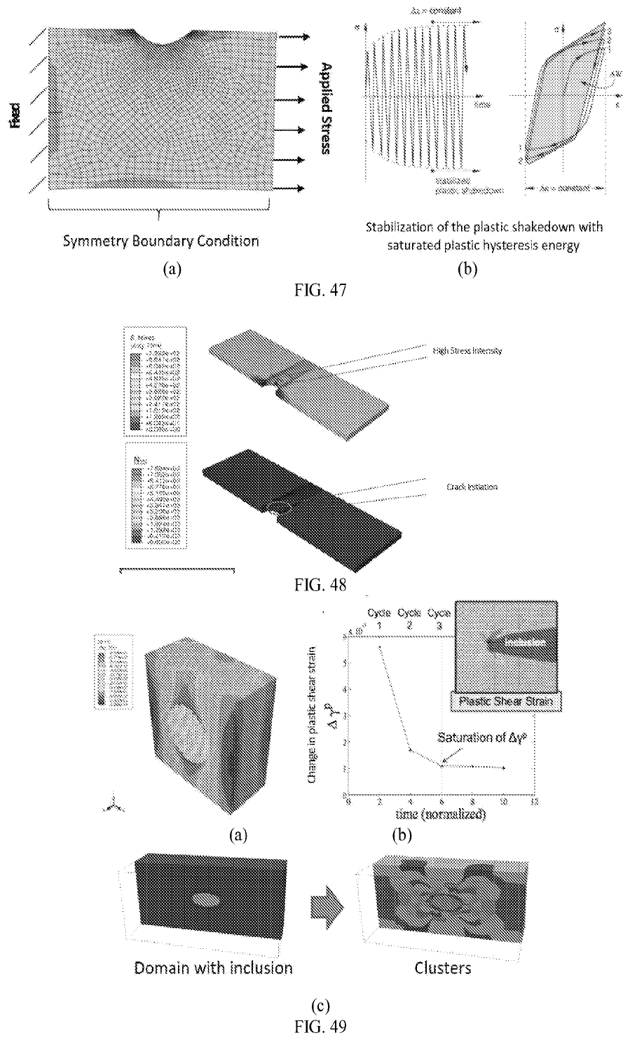

FIG. 47 shows low cycle fatigue modeling.

FIG. 48 shows computational model of low cycle fatigue.

FIG. 49 panels (a)-(c) show high cycle fatigue modeling with microstructure. FIG. 49

The aforementioned processes are detailed in Nakatani, Masanori, et al. “Effect of Surface Roughness on Fatigue Strength of Ti-6Al-4V Alloy Manufactured by Additive Manufacturing.” Procedia Structural Integrity 19 (2019): 294-301, and Yu, C., Kafka, O. L., & Liu, W. K. (2019). Self-consistent clustering analysis for multiscale modeling at finite strains. Computer Methods in Applied Mechanics and Engineering, 349, 339-359, which are hereby incorporated by reference in their entirety.

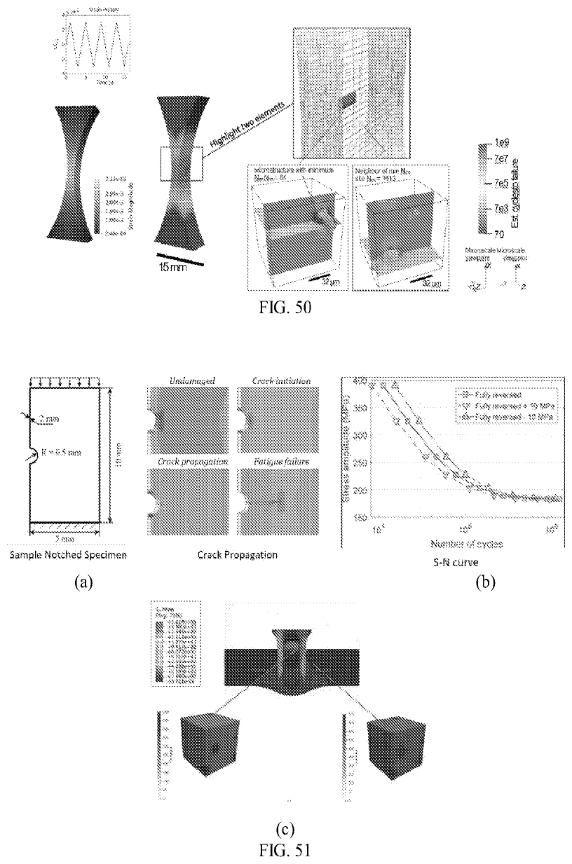

FIG. 50 shows high cycle fatigue modeling with microstructure. In particular, microstructure, e.g. porosity, inclusions, precipitates, and dislocations, is vital for fatigue life estimate in AM. Depending on distance between inclusion/porosity and rough surface fatigue mechanism will change. The present invetion has developed experiment-based multiscale fatigue simulation.

FIG. 51 shows space-time self-consistent clustering analysis (XTSCA). The present invention has developed multiscale simulation code called extended space-time self-consistent clustering analysis (XTSCA). The theory computes (1) coupon scale fatigue life using GPU-based space time code (order of magnitude faster than traditional FEM); and (2) microscale response using Self-consistent Clustering Analysis.

### 3. Process-Structure ML Using Published Data—Generalized Mechanistic Knowledge Transfer.

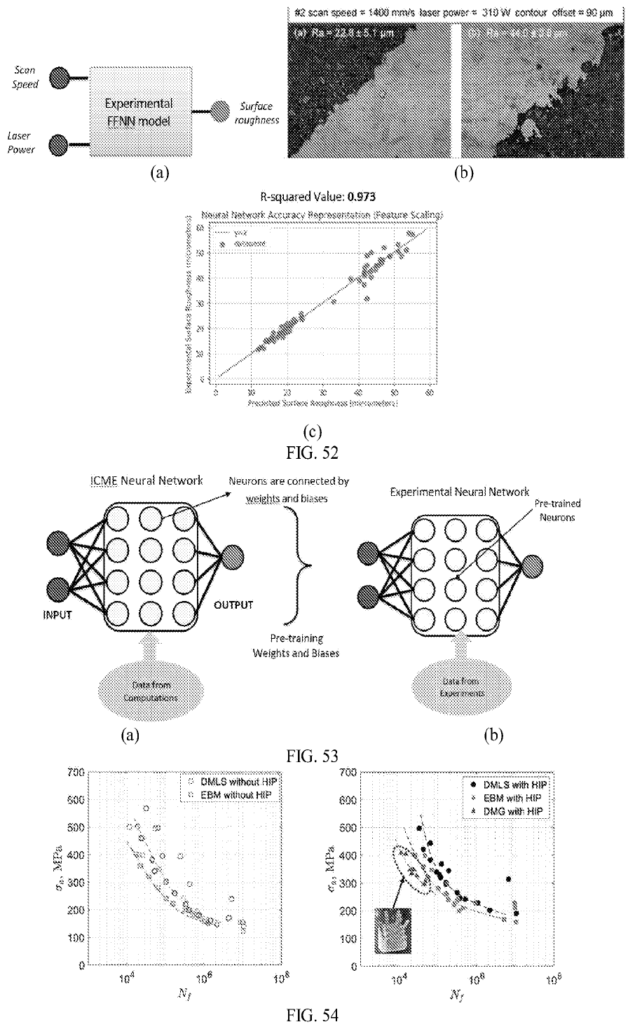

FIG. 52 shows process-structure ML using published data.

TABLE 21-1
Training/validation data for process-structure ML.

| Laser | Scan | Surface | |
|---|---|---|---|
| power | speed | roughness | Data |
| (W) | (m/s) | (um) | Samples |
| 258-362 | 0.7-1.4 | 11.89-57.54 | 90 |

TABLE 21-2
Fatigue life N_{f}, Surface roughness
Rₐ, Hardness HV, Postprocessing HIP.

| | Vickers | Surface | Applied | |
|---|---|---|---|---|
| | Hardness | roughness | stress | |
| | range | range | range | Data |
| | (kgf/mm2) | (um) | (MPa) | Samples |
| EBM with HIP | 320.2-345 | 32-35.5 | 160-402.5 | 30 |
| EBM without HIP | 341.2-369 | 32-37 | 122.5-401.27 | 32 |
| DMLS with HIP | 310-340 | 12-14.02 | 191.14-497.4 | 18 |
| DMLS without HIP | 377.6-378 | 11.5-14.02 | 140.50-567.58 | 32 |
| DMG with HIP | 234.24 | 9.45-14.26 | 295.53-407.97 | 11 |
| (STTR exp) | | | | |

EBM: Electron Beam Melting; DMLS: Direct Metal Laser Sintering; HIP: Hot isostatic pressing; DMG: Powder bed machine from DMG MORI.

FIG. 53 shows pre-training weights and biases of the neural network. In this method, the weights and biases of a neural network is trained first with similar data. In particular, FIG. 53(a) shows ICME neural network, and FIG. 53(b) shows experimental neural network.

FIG. 54 shows EBM process and DMLS process with HIP post-processing. The present invention shows that (1) EBM performance is worse than DMLS process under same post-processing; (2) DMLS data is more scattered; and (3) and there is no single model curve-fit describes all 3 processes.

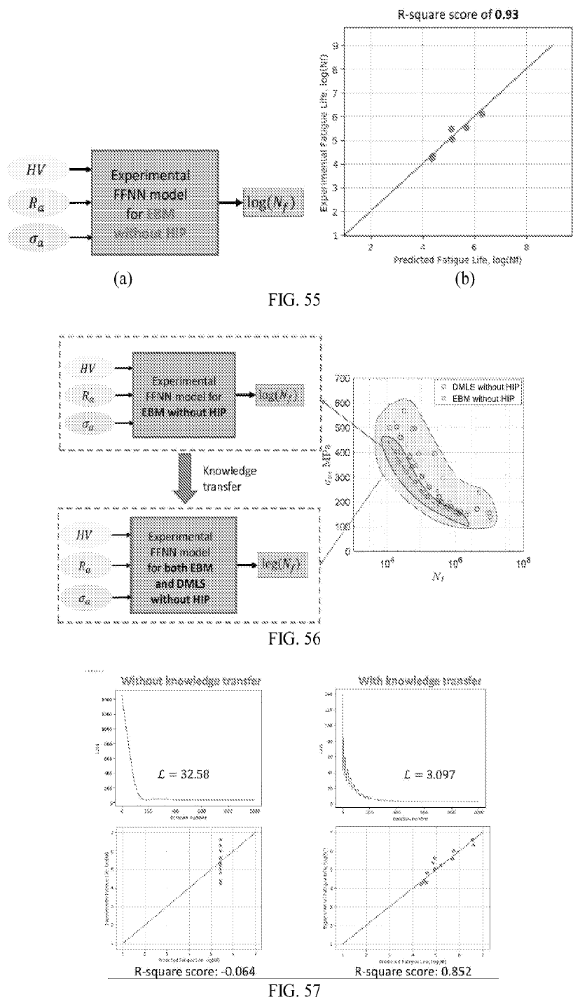

FIG. 55 shows ML model for fatigue prediction, EBM without HIP. The loss function is

$$\begin{matrix}find W , b \\ arg min , ℒ = \frac{1}{N} {\sum }_{i = 1}^{N} {( log ( \text{?} ) - log ( \text{?} ) )}^{2}\end{matrix}$$

$$\text{?} \text{indicates text missing or illegible when filed}$$

Ñ_{f}^{l}: fatigue life from experiment
N_{f}^{l}: fatigue life from ML prediction
   Training data is 85%, and testing data is 15%.

FIG. 56 shows mechanistic knowledge transfer model, EBM+DMLS, no HIP, in particular, using the knowledge learned from the red region for EMB without HIP to extrapolate the results to the entire domain for both EBM and DMLS without HIP by mechanistic knowledge transfer.

FIG. 57 shows knowledge transfer reduces learning iterations and error. In particular, FFNN model evolves from EBM to EBM+DMLS (without HIP) through mechanistic knowledge transfer. R-square score is significantly increased from −0.064 to 0.852.

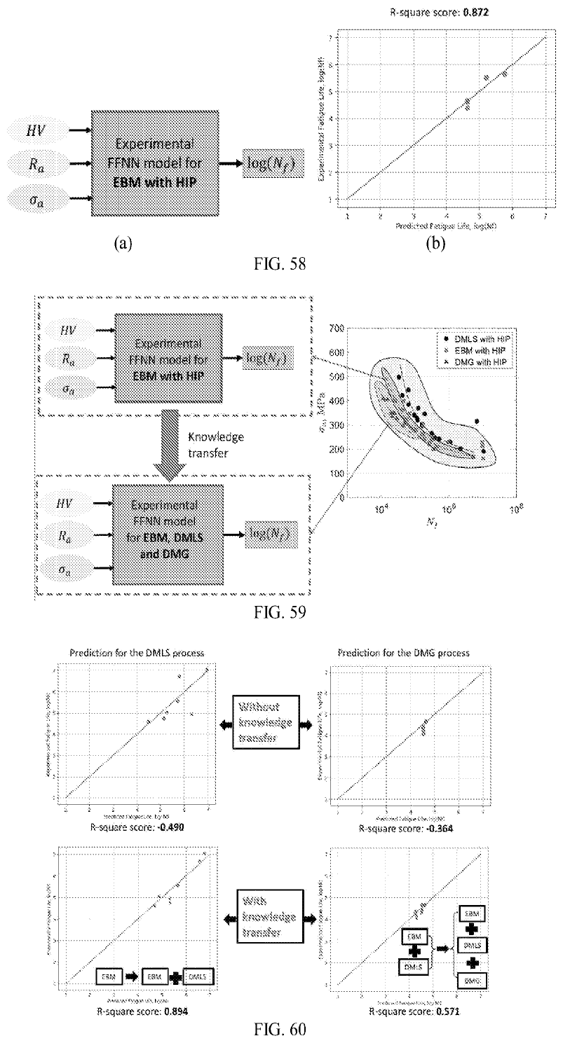

FIG. 58 shows ML model for fatigue prediction, EBM with HIP. The loss function is

$$\begin{matrix}find W , b \\ arg min , ℒ = \frac{1}{N} {\sum }_{i = 1}^{N} {( log ( \text{?} ) - log ( {\tilde{N}}_{f}^{i} ) )}^{2}\end{matrix}$$

$$\text{?} \text{indicates text missing or illegible when filed}$$

Ñ_{f}^{l}: fatigue life from experiment
N_{f}^{l}: fatigue life from ML prediction
   Training data is 85%, and testing data is 15%.

FIG. 59 shows mechanistic knowledge transfer model, EBM+DMLS with HIP. The goal is using knowledge transfer to give accurate prediction for all three processes using knowledge from EBM. FIG. 60 shows that knowledge transfer reduces learning iteration and error.

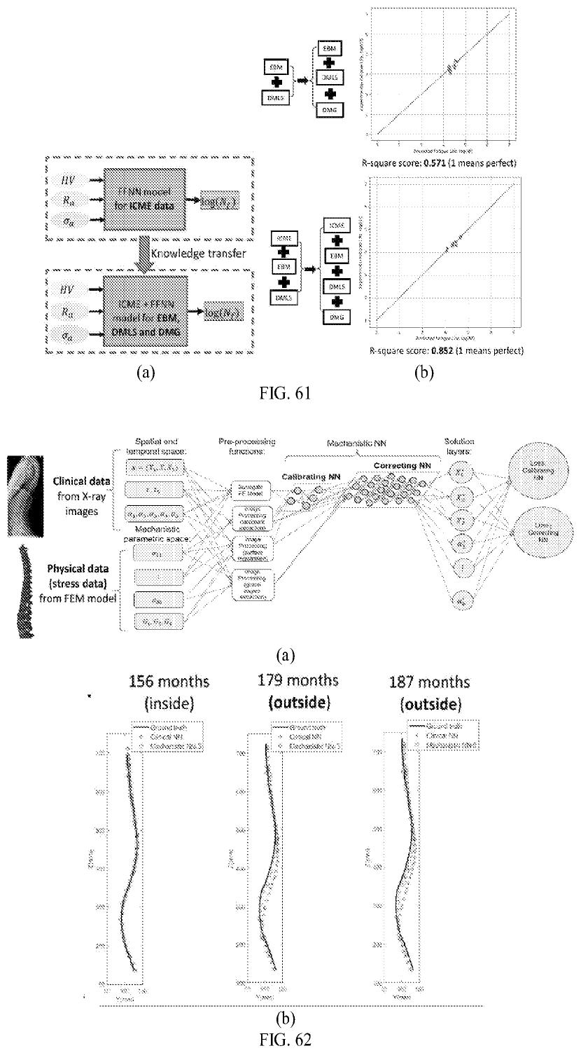

FIG. 61 shows a process and results that ICME-mechanistic knowledge transfer for better extrapolation. In particular, introduction of ICME data for knowledge transfer improves prediction for limited data obtained from DMG MORI machine (very different from previously published data).

### Example 17—Prediction of Spinal Deformity Curve Progression using HiDeNN

FIG. 62 shows a process for Prediction of Spinal Deformity Curve Progression using HiDeNN. Patient with double curvature is used as example for illustration. FIG. 62 panel (a) shows the process for the predictio of spinal deformity curve progression by HiDeNN system,, while FIG. 62 panel (b) show the result of perdiciton. Data description are shown in Table 23-1. Table 23-2 reflectes the comparison of NNs.

TABLE 23-1
X-Ray and patient data description

| Indentification of x-ray images | Age (month) |
|---|---|
| Initial x-ray image | 124 |
| Trainig x-ray images | {139, 149, 160, 168} |
| x-ray images for comparing | {156, 179, 187} |
| with results from NN | |

TABLE 23-2
Comparison of NNs.

| | Ages included | | | |
|---|---|---|---|---|
| | in stress | Prediction | Prediction | |
| | datasets | Inside | Outside | |
| Types of NN | (Month) | 156 | 179 | 187 |
| Clinical NN | — | 4.38% | 20.14% | 31.70% |
| Mechanistic NN-1 | 124 | 5.14% | 24.16% | 35.90% |
| Mechanistic NN-2 | 124, 139 | 3.12% | 16.72% | 22.45% |
| Mechanistic NN-3 | 124, 139, 149 | 1.17% | 9.82% | 16.59% |
| Mechanistic NN-4 | 124, 139, 149, | 1.06% | 6.51% | 12.44% |
| | 160 | | | |
| Mechanistic NN-5 | 124, 139, 149, | 0.70% | 4.38% | 10.43% |
| | 160, 168 | | | |

The foregoing description of the exemplary embodiments of the invention has been presented only for the purposes of illustration and description and is not intended to be exhaustive or to limit the invention to the precise forms disclosed. Many modifications and variations are possible in light of the above teaching.

While there has been shown several and alternate embodiments of the present invention, it is to be understood that certain changes can be made as would be known to one skilled in the art without departing from the underlying scope of the invention as is discussed and set forth above and below including claims and drawings. Furthermore, the embodiments described above and claims set forth below are only intended to illustrate the principles of the present invention and are not intended to limit the scope of the invention to the disclosed elements.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in the description of this invention, are incorporated herein by reference in their entireties and to the same extent as if each reference was individually incorporated by reference.

1. A Hierarchical Deep Learning Neural Networks-Artificial Intelligence (HiDeNN-AI) system for data processing, comprising:
a data collection module collecting data;
an analyzing component extracting at least one feature from the data, and processing the extracted at least one feature to produce at least one reduced feature; and
a learning component producing at least one mechanistic equation based on the at least one reduced feature.

2. The HiDeNN-AI system according to claim 1, wherein the data is collected from at least one of the sources comprising measurement and sensor detection, computer simulation, existing databases and literatures.

3. The HiDeNN-AI system according to claim 1, wherein the data is in one of formats comprising images, sounds, numeric numbers, mechanistic equations, and electronic signals.

4. The HiDeNN-AI system according to claim 1, wherein the data collected by the data collection module is multifidelity.

5. The HiDeNN-AI system according to claim 1, wherein the analyzing component further comprises:
a feature extraction module extracting the at least one feature from the data; and
a dimension reduction module reducing the size of the at least one feature.

6. The HiDeNN-AI system according to claim 5, wherein the at least one extracted feature is extracted by a method comprising Fourier, wavelet, convolutional, or Laplace transformation.

7. The HiDeNN-AI system according to claim 1, wherein the at least one extracted feature has mechanistic and interpretable nature.

8. The HiDeNN-AI system according to claim 1, wherein the dimension reduction module produces at least one reduced feature by reducing the size of the at least one extracted feature; wherein the dimension of the at least one extracted feature is reduced during the reducing process.

9. The HiDeNN-AI system according to claim 1, wherein the at least one non-dimensional number is derived during the process of reducing the size of the at least one extracted feature.

10. The HiDeNN-AI system according to claim 1, wherein the at least one extracted feature comprises a first extracted feature and a second extracted feature.

11. The HiDeNN-AI system according to claim claim 10, wherein the first extracted feature is reduced to produce a first reduced feature, and the second extracted feature is reduced to produce a second reduced feature.

12. The HiDeNN-AI system according to claim 1, wherein the learning component further comprises:
a regression module analyzing the at least one reduced feature; and
a discovery module producing at least one hidden mechanistic equation based on the analyzing results of the at least one reduced feature.

13. The HiDeNN-AI system according to claim 12, wherein a relationship between the first reduced feature and the second reduced feature is established by the regression module during the analyzing process.

14. The HiDeNN-AI system according to claim 13, wherein the analyzing process comprising a step of regression and classification of deep neural networks (DNNs).

15. The HiDeNN-AI system according to claim 1, wherein the hidden mechanistic equation relates an input parameter to a target property.

16. The HiDeNN-AI system according to claim 1, wherein a model order reduction is produced by the discovery module based on the hidden mechanistic equation.

17. The HiDeNN-AI system according to claim 1, further comprising:
a knowledge database module, wherein the knowledge database module stores knowledge comprising at least one component comprising: the collected data, the at least one extracted feature, the at least one reduced feature, the relationship between the reduced features, the hidden equation, and the model order reduction.

18. The HiDeNN-AI system according to claim 1, further comprising:
a developer interface module in communication with the knowledge database module, wherein the developer interface module develops new knowledge for storing in the knowledge database module.

19. The HiDeNN-AI system according to claim 1, wherein the develop interface module is in communication with at least one of the collection module; the analyzing component, and the learning component.

20. The HiDeNN-AI system according to claim 1, wherein the develop interface module receives a data science algorithm input from an user.

21. The HiDeNN-AI system according to claim 1, wherein the analyzing component and the learning component process the collected date using the data science algorithm.

22. The HiDeNN-AI system according to claim 1, further comprising:
a system design module in communication with knowledge database module.

23. The HiDeNN-AI system according to claim 1, wherein the system design module produces a new system or a new design using the knowledge in the knowledge database module, and without using the data collection module, analyzing component, and learning component.

24. The HiDeNN-AI system according to claim 1, further comprising:
a user interface module for receiving inputs from the user and output knowledge, the new system, or new design to the user.

25. The HiDeNN-AI system according to claim 1, further comprising:
an optimized system module optimizing the new system or new design according to the received inputs.

26. A method for data processing using a Hierarchical Deep Learning Neural Networks-Artificial Intelligence (HiDeNN-AI) system, comprising steps of:
collecting data with a data collection module;
extracting at least one feature from the data and processing the extracted feature to produce at least one reduced feature with an analyzing component; and
producing at least one mechanistic equation or model order reduction based on the at least one reduced feature with a learning component.

27. The method according to claim 26, wherein the data is collected from at least one of the sources selected from a group comprising measurement and sensor detection, computer simulation, existing databases and literatures.

28. The method according to claim 26, wherein the data is in one of formats comprising images, sounds, numeric numbers, mechanistic equations, and electronic signals.

29. The method according to claim 26, wherein the data collected by the data collection module is multifidelity.

30. The method according to claim 26, wherein extraction of the at least one feature from the data is accomplished by a feature extraction module of the analyzing component; and wherein reduction the size of the at least one feature is accomplished by a dimension reduction module of the analyzing component.

31. The method according to claim 30, wherein the extraction process uses a method comprising Fourier, wavelet, convolutional, or Laplace transformation.

32. The method according to claim 26, wherein the reducing process by the dimension reduction module produces at least one reduced feature by reducing the size of the at least one extracted feature; wherein the dimension of the at least one extracted feature is reduced during the reducing process.

33. The method according to claim 26, wherein at least one non-dimensional number is derived during the reducing process.

34. The method according to claim 26, wherein the at least one extracted feature comprises a first extracted feature and a second extracted feature.

35. The method according to claim 26, wherein the first extracted feature is reduced to produce a first reduced feature, and the second extracted feature is reduced to produce a second reduced feature.

36. The method according to claim 26, further comprising steps of:
analyzing the at least one reduced feature by a regression module of the learning component; and
producing at least one hidden mechanistic equation by a discovery module of the learning component based on the anazlyzing results of the at least one reduced feature.

37. The method according to claim 26, further comprising a step of:
establishing a relationship between the first reduced feature and the second reduced feature by the regression module during the analyzing process.

38. The method according to claim 26, wherein the analyzing process comprising a step of regression and classification of DNNs.

39. The method according to claim 26, further comprising a step of:
relating an input parameter to a target property by the hidden mechanistic equation.

40. The method according to claim 26, further comprising a step of:
producing a model order reduction by the discovery module based on the hidden mechanistic equation.

41. The method according to claim 26, further comprising a step of:
storing knowledge comprising at least one component comprising: the collected data, the at least one extracted feature, the at least one reduced feature, the relationship between the reduced features, the hidden equation, and the model order reduction in a knowledge database module.

42. The method according to claim 26, further comprising a step of:
developing new knowledge for storing in the knowledge database module by a developer interface module in communication with the knowledge database module.

43. The method according to claim 26, wherein the develop interface module is in communication with at least one of the collection module, the analyzing component, and the learning component.

44. The method according to claim 26, further comprising a step of:
receiving an data science algorithm input from an user by the develop interface module.

45. The method according to claim 26, wherein the analyzing component and the learning component process the collected date using the data science algorithm.

46. The method according to claim 26, further comprising a step of:
producing a new system or a new design using the knowledge in the knowledge database module by a system design module.

47. The method according to claim 26, wherein the new system or a new design is produced by the system design module without communication with the data collection module, analyzing component, and learning component.

48. The method according to claim 26, further comprising a step of:
receiving inputs from the user by a user interface module; and
outputting knowledge, the new system, or new design to the user by the user interface module.

49. The method according to claim 26, further comprising a step of:
optimizing the new system or new design according to the received inputs by an optimized system module.

50. A non-transitory tangible computer-readable medium storing instructions which, when executed by one or more processors, cause a system to perform a method for design optimization and/or performance prediction of a material system, wherein the method is in accordance with claim 26.
